(19) United States
(12) Patent Application Publication
(10) Pub. No.: US 2026/0316396 A1
(43) Pub. Date: Oct. 15, 2026

(54) BRACING STRUCTURES FOR ADDITIVE MANUFACTURING

(71) Applicant: Thermwood Corporation, Dale, IN (US)

(72) Inventors: Scott G. VAAL, Jasper, IN (US); Matthew R. WEBB, Huntingburg, IN (US)

(73) Assignee: Thermwood Corporation, Dale, IN (US)

(21) Appl. No.: 19/642,028

(22) Filed: Apr. 8, 2026

Related U.S. Application Data
(60) Provisional application No. 63/787,466, filed on Apr. 11, 2025.

(51) Int. Cl. B29C 64/393; B29C 64/209; B29C 64/227; B33Y 10/00; B33Y 30/00; B33Y 50/02

(52) U.S. Cl. CPC B29C 64/393; B29C 64/209; B29C 64/227; B29C 64/40; B33Y 10/00; B33Y 30/00; B33Y 50/02

(57) ABSTRACT

A system for forming a part using additive manufacturing includes: an applicator assembly including a nozzle connected downstream of an extruder, a plurality of servomotors for positioning the applicator assembly, and a controller. The controller is configured to generate instructions for controlling operation of the plurality of servomotors to position the applicator assembly. The controller is further configured to: receive a model of a part, determine a brace type from a plurality of brace types, generate, on the model of the part, a brace shape, identify a portion of the brace shape located on an interior of the model of the part, and based on the brace type, generate the instructions for controlling operation of the plurality of servomotors to deposit material on the portion of the brace shape located on the interior of the model of the part.

### CROSS-REFERENCE TO RELATED APPLICATION

This application claims the benefit of priority to U.S. Application No. 63/787,466, filed Apr. 11, 2025, which is incorporated herein by reference in its entirety.

### TECHNICAL FIELD

Aspects of the present disclosure relate to apparatus and methods for fabricating components. In some instances, aspects of the present disclosure relate to apparatus and methods for fabricating components (such as, e.g., automobile parts, medical devices, machine components, consumer products, etc.) via additive manufacturing techniques or processes, such as, e.g., three-dimensional (3D) printing.

### BACKGROUND

Additive manufacturing techniques and processes generally involve the buildup of one or more materials, e.g., layering, to make a net or near net shape (NNS) object, in contrast to subtractive manufacturing methods. Though “additive manufacturing” is an industry standard term (ASTM F2792), additive manufacturing encompasses various manufacturing and prototyping techniques known under a variety of names, including, e.g., freeform fabrication, 3D printing, rapid prototyping/tooling, etc. Additive manufacturing techniques may be used to fabricate simple or complex components from a wide variety of materials. For example, a freestanding object may be fabricated from a computer-aided design (CAD) model.

A particular type of additive manufacturing is commonly known as 3D printing. One such process commonly referred to as Fused Deposition Modeling (FDM) or Fused Layer Modeling (FLM) comprises melting a thin layer of thermoplastic material and applying this material in layers to produce a final part. This is commonly accomplished by passing a continuous thin filament of thermoplastic material through a heated nozzle, or by passing thermoplastic material into an extruder with an attached nozzle, which melts and applies the melted thermoplastic material to a structure being printed, building up the structure. The melted thermoplastic material may be applied to the existing structure in layers, melting and fusing with the existing material (e.g., the previously deposited layers of the melted thermoplastic material of the structure), to produce a solid finished part.

The filament used in the aforementioned process may be produced, for example, using an extruder, which may include a steel extruder screw configured to rotate inside of a heated steel barrel. Thermoplastic material in the form of small pellets may be introduced into one end of the rotating screw. Friction from the rotating screw, combined with heat from the barrel may soften the thermoplastic material, which may then be forced under pressure through a small round opening in a die that is attached to the front of the extruder barrel. In doing so, a “string” of material may be extruded, after which the extruded string of material may be cooled and coiled up for use in a 3D printer or other additive manufacturing system.

Melting a thin filament of material in order to 3D print an item may be a slow process, which may be suitable for producing relatively small items or a limited number of items. The melted filament approach to 3D printing may be too slow to manufacture large items. However, the fundamental process of 3D printing using molten thermoplastic materials may offer advantages for the manufacture of larger parts or a larger number of items.

In some instances, the process of 3D printing a part may involve a two-step process. This two-step process, commonly referred to as near-net-shape, may begin by printing a part to a size slightly larger than needed, e.g., printing using a larger bead, then machining, milling, or routing the part to the final size and shape. The additional time required to trim the part to a final size may be compensated for by the faster printing process.

A method of additive manufacturing, or 3D printing, may include forming and extruding a bead of flowable material (e.g., molten thermoplastic), applying the bead of material in a strata of layers to form a facsimile of an article, and machining the facsimile to produce an end product. Such a process may be achieved using an extruder mounted on a computer numeric controlled (CNC) machine with controlled motion along at least the x-, y-, and z-axes. In some cases, the flowable material, such as, e.g., molten thermoplastic material, may be infused with a reinforcing material (e.g., strands of fiber or a combination of materials) to enhance the material's strength.

Some CNC programs may generate a print program including a tool path for each layer using a “slicing process”. The slicing process may divide or “slice” a computer model of the part to be printed into layers. Typically, slicing processes divide a part into layers having approximately the same print parameters. For example, the slicing process may use a constant thickness for each layer, e.g., a thickness approximately equal to the thickness of the print bead. After dividing the part into layers, a tool path for each layer is generated such that the tool path guides the beads of material being deposited to reproduce the shape of each layer. That is, the tool path directs movement of a nozzle for depositing the material in a layer.

During the slicing process, a number of print parameters for each layer may be taken into account such as, e.g., a width and/or a thickness of print bead, a width of the perimeter of the part, a start location and a stop location of an applicator head including the nozzle, an infill pattern, and a print speed. For example, slicing processes typically divide parts into layers having constant print parameters. Such slicing processes may be inefficient and limited. For example, by maintaining all printing parameters constant for every layer of a part, typical slicing programs cannot optimize print parameters of different sections of a part. It may be desirable, however, to produce a part using different print parameters at separate areas of the part, e.g., printing, an outside perimeter of the part with print beads having dimensions different from the print beads used to form the internal structures of the part.

### SUMMARY

Aspects of the present disclosure relate to, among other things, methods and apparatus for fabricating components via additive manufacturing or 3D printing techniques. Each of the aspects disclosed herein may include one or more of the features described in connection with any of the other disclosed aspects. In one aspect, the present disclosure relates to systems and methods for creating or adjusting bracing structures.

For at least some parts, it is beneficial to add bracing or reinforcement structure.

In one aspect, a system for forming a part using additive manufacturing may include an applicator assembly including a nozzle connected downstream of an extruder, a plurality of servomotors for positioning the applicator assembly, and a controller. The controller may be configured to generate instructions for controlling operation of the plurality of servomotors to position the applicator assembly. The controller may be further configured to: receive a model of a part, generate, on the model of the part, a brace shape, identify a portion of the brace shape located on an interior of the model of the part, and generate the instructions for controlling operation of the plurality of servomotors to deposit material on the portion of the brace shape located on the interior of the model of the part.

In another aspect, a method for forming a part using additive manufacturing may include receiving a model of a part, generating, on the model of the part, a brace shape, identifying a portion of the brace shape that is located on an interior of the model of the part, and generating instructions for controlling operation of a plurality of servomotors for depositing material on the portion of the brace shape located on the interior of the model of the part.

As used herein, the terms “comprises,” “comprising,” or any other variation thereof, are intended to cover a non-exclusive inclusion, such as a process, method, article, or apparatus. The term “exemplary” is used in the sense of “example,” rather than “ideal.” As used herein, the terms “about,” “generally,” “substantially,” and “approximately,” indicate a range of values within +/−5% of the stated value unless otherwise stated. As used herein, the term “part” refers to a finished product of the printing process. Each part may comprise one or more sections. As used herein the term “section” refers to a portion or division of a part. For example a section may be a plurality of layers of a part, a quadrant, hemisphere, or other division of the part, an internal structure of a part, or an outside structure of a part.

It may be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate exemplary aspects of the present disclosure and together with the description, serve to explain the principles of the disclosure.

FIG. 1 is a perspective view of an exemplary CNC machine operable pursuant to an additive manufacturing process to form articles or parts, according to an aspect of the present disclosure;

FIG. 2 is an enlarged perspective view of an exemplary carrier and applicator head assembly of the exemplary CNC machine shown in FIG. 1;

FIG. 3 is an enlarged cutaway view of an exemplary applicator head assembly shown in FIG. 2;

FIG. 4 is an exemplary screen shot of a graphical user interface for selection of a toolpath type for use in the slicing process;

FIG. 5 is an exemplary screen shot of a graphical user interface prompting the input of print parameters of a geometry subcategory;

FIG. 6 is a perspective view of an exemplary part manufactured using a printing process generated by the slicing process of the present disclosure;

FIG. 7A is a perspective view of an additional exemplary part manufactured using a printing process generated by the slicing process of the present disclosure;

FIG. 7B is an exploded view of the exemplary part of FIG. 7A, illustrating the various subsections thereof;

FIG. 8 is an exemplary screen shot of a graphical user interface prompting input of print parameters of the toolpath subcategory of the general category;

FIG. 9 is an exemplary screen shot of a graphical user interface prompting input of print parameters of the process subcategory of the general category;

FIG. 10 is an exemplary screen shot of a graphical user interface prompting input of print parameters of the tool subcategory of the general category;

FIG. 11 is an exemplary screen shot of a graphical user interface prompting input of print parameters of a passes subcategory of a boundary category;

FIG. 12 is an exemplary screen shot of a graphical user interface prompting input of print parameters of a process subcategory of a boundary category;

FIG. 13 is an exemplary screen shot of a graphical user interface prompting input of print parameters of a bead geometry subcategory of the boundary category;

FIG. 14 is an exemplary screen shot of a graphical user interface prompting input of print parameters of the passes subcategory of a fill category;

FIG. 15 is a top view diagram of an exemplary fill path generated using a one-way fill style;

FIG. 16 is a top view diagram of an exemplary fill path generated using a simple zigzag fill style;

FIG. 17 is a top view diagram of an exemplary fill path generated using a smart zigzag fill style;

FIG. 18 is a top view diagram of an exemplary fill path generated using a smart zigzag constant overlap fill style;

FIG. 19 is a top view diagram of an exemplary fill path generated using a sparse zigzag fill style;

FIG. 20 is an exemplary screen shot of a graphical user interface for the input of fill style parameters;

FIG. 21 is a flowchart of a method of executing the slicing process and manufacturing a part; and

FIGS. 22A-22D are views showing a model, a brace structure for the model, and a part formed from the model and the brace structure.

FIGS. 23A-23D are images showing stages for processing a solid model to generate brace geometry.

FIGS. 24A-24E are views showing generation of chains and brace passes for an example layer.

FIGS. 25A-25D are views showing generation of generation of open chains and brace passes for an example layer.

FIGS. 26A-26C are views showing an example process for determining the direction of an open chain or brace pass of an example layer.

FIGS. 27A-27D are views showing an example process for creation of a double type chain or brace.

FIGS. 28A-28D are views showing an example process for creation of a connected type chain or brace.

FIGS. 29A-29D are views showing an example process for creation of a inverted type chain or brace.

FIGS. 30A-30E are views showing an example process for creation of a intersection type chain or brace.

FIGS. 31A-31D are views showing an example process for creation of an advanced type chain or brace.

FIGS. 32A-32D are views showing an example process for creation of a closed type chain or brace.

FIGS. 33A-33C are views showing an example process for creation of a hybrid type chain or brace.

### DETAILED DESCRIPTION

The present disclosure is drawn to, among other things, methods and apparatus for fabricating components, parts, or articles via additive manufacturing such as, e.g., 3D printing. Specifically, the methods and apparatus described herein may be drawn to a method of dividing a part into sections and layers.

For purposes of brevity, the methods and apparatus described herein will be discussed in connection with the fabrication of parts from thermoplastic materials. However, those of ordinary skill in the art will readily recognize that the disclosed apparatus and methods may be used with any flowable material suitable for additive manufacturing.

### Additive Manufacturing Control System

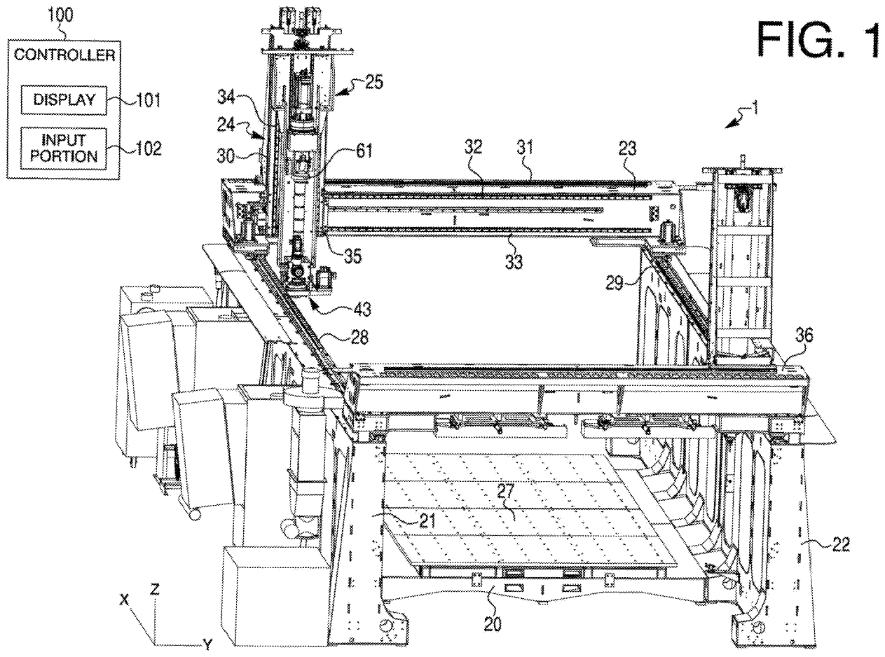

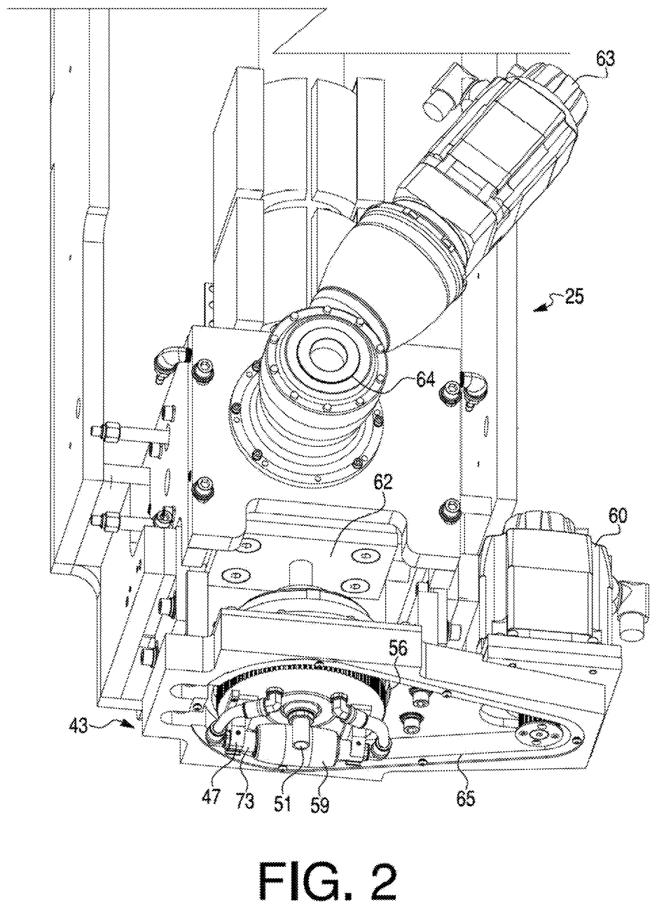

Referring to FIG. 1, there is illustrated a CNC machine 1 embodying aspects of the present disclosure. CNC machine 1 may include a controller 100 operatively connected to CNC machine 1 for displacing an applicator head 43 (see FIG. 2) along a longitudinal line of travel, or x-axis, a transverse line of travel, or a y-axis, and a vertical line of travel, or z-axis, in accordance with a program, (e.g., a print program or process) inputted or loaded into the controller 100 for performing an additive manufacturing process to form a desired component or part, as will be described in further detail below. Controller 100 may include a display 101 (e.g., screen) and an input portion 102, as schematically illustrated in FIG. 1. Optionally, input portion 102 may include one or more of a keyboard, buttons, joystick, mouse, or the like, for entry of data by a user. Optionally, display 101 may be a touch screen display in which data and/or user selections may be directly input to controller 100. In such a case, controller 100 may not include input portion 102.

CNC machine 1 may be configured to print or otherwise build 3D parts from digital representations of the 3D parts (e.g., AMF and STL format files). For example, in an extrusion-based additive manufacturing system (e.g., a 3D printing machine), a 3D part may be printed from a digital representation of the 3D part in a layer-by-layer manner by extruding a flowable material (e.g., thermoplastic material with or without reinforcements). With reference to FIG. 2, the flowable material may be extruded through an extrusion tip or nozzle 51 carried by and applicator head 43 of the CNC machine 1, and the flowable material may be deposited as a sequence of beads or layers on a substrate in an x-y plane. The extruded, flowable material may fuse to a previously deposited layer of material and may solidify upon a drop (e.g., decrease) in temperature. The position of applicator head 43 relative to the substrate may then be incrementally advanced along a z-axis (perpendicular to the x-y plane), and the process may then be repeated to form a 3D part resembling the digital representation.

CNC machine 1, as shown in FIG. 1, includes a bed 20 provided with a pair of transversely spaced side walls 21 and 22, a printing gantry 23 and a trimming gantry 36 supported on opposing side walls 21 and 22, a carriage 24 mounted on printing gantry 23, a carrier 25 mounted on carriage 24, an extruder 61 having and extruder screw (not shown), and the applicator head (also referred herein as an applicator assembly) 43 mounted on carrier 25. Located on bed 20 between side walls 21 and 22 is a worktable 27 provided with a support surface. The support surface may be disposed in an x-y plane and may be fixed, or displaceable, along an x-axis and/or a y-axis. For example, in a displaceable version, worktable 27 may be displaceable along a set of rails mounted to bed 20. Displacement of worktable 27 may be achieved using one or more servomotors and one or more of guide rails mounted on bed 20 and operatively connected to worktable 27. Printing gantry 23 is disposed along the y-axis, supported on side walls 21 and 22. In FIG. 1, printing gantry 23 is mounted on the set of guide rails 28 and 29, which are located along a top surface of side walls 21 and 22.

Printing gantry 23 may either be fixedly or displaceably mounted, and in some aspects, printing gantry 23 may be disposed along the x-axis. In an exemplary displaceable version, one or more servomotors may control movement of printing gantry 23. For example, one or more servomotors may be mounted on printing gantry 23 and operatively connected to tracks, e.g., guide rails 28, 29, provided on the side walls 21 and 22 of bed 20.

Carriage 24 is supported on printing gantry 23 and is provided with a support member 30 mounted on and displaceable along one or more guide rails 31, 32 and 33 provided on printing gantry 23. Carriage 24 may be displaceable along a y-axis on one or more guide rails 31, 32 and 33 by a servomotor mounted on the printing gantry 23 and operatively connected to support member 30. Carrier 25 is mounted on one or more vertically disposed guide rails 34 and 35 supported on carriage 24 for displacement of carrier 25 relative to carriage 24 along the z-axis. Carrier 25 may be displaceable along the z-axis by a servomotor mounted on carriage 24 and operatively connected to carrier 25.

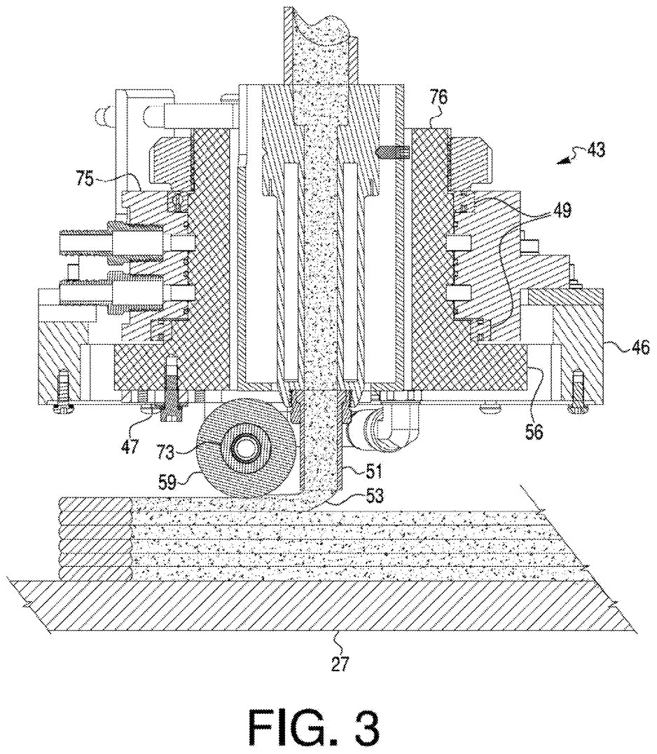

As best shown in FIG. 2, also fixedly mounted to the bottom of carrier 25) is a positive displacement gear pump 62 (e.g., melt pump), which may be driven by a servomotor 63, through a gearbox 64. Said gear pump 62 receives molten plastic from extruder 61, shown in FIG. 1. A compression roller 59, rotatable about a nonrotatable (e.g., fixed) axle 73, for compressing deposited flowable material (e.g., thermoplastic material) may be mounted on a carrier bracket 47. Roller 59 may be movably mounted on carrier bracket 47, for example, rotatably or pivotably mounted. Roller 59 may be mounted so that a center portion of roller 59 is aligned with a nozzle 51 of applicator head 43, and roller 59 may be oriented tangentially to nozzle 51. Roller 59 may be mounted relative to nozzle 51 so that material, e.g., one or more beads of flowable material (such as thermoplastic resins), discharged from nozzle 51 are smoothed, flattened, leveled, and/or compressed by roller 59, as depicted in FIG. 3. One or more servomotors 60 may be configured to move, e.g., rotationally displace, carrier bracket 47 via a pulley 56 and belt 65 arrangement. In some embodiments, carrier bracket 47 may be rotationally displaced via a sprocket and drive-chain arrangement (not shown), or by any other suitable mechanism.

With continuing reference to FIG. 3, applicator head 43 may include a housing 46 having a rotary union mounted therein. Such a rotary union may include an inner hub 76 rotatably mounted within and relative to an outer housing 75. For example, inner hub 76 may rotate about a longitudinal axis thereof relative to outer housing 75 via one or more roller bearings 49. Carrier bracket 47 may be mounted, e.g., fixedly mounted to inner hub 76, journaled in roller bearing 49. Roller bearing 49 may allow roller 59 to rotate about nozzle 51.

As shown in FIGS. 2-3, an oversized molten bead of a material 53 (e.g., a thermoplastic material) under pressure from a source disposed on carrier 25 (e.g., one or more of extruder 61 and an associated polymer or gear pump 62) may be flowed to applicator head 43, which may be fixedly (or removably) connected to, and in communication with nozzle 51. In use, material 53 (e.g., melted thermoplastic material) may be heated sufficiently to form a large molten bead thereof, which may be delivered through applicator nozzle 51 to form multiple rows of deposited material 53 on a surface of worktable 27. In some embodiments, beads of molten material deposited by nozzle 51 may be substantially round in shape prior to being compressed by roller 59. Exemplary large beads may range in size from approximately 0.4 inches to over 1 inch in diameter. For example, a 0.5 inch bead may be deposited by nozzle 51 and then flattened by roller 59 to a layer approximately 0.2 inches thick by approximately 0.83 inches wide. Such large beads of molten material may be flattened, leveled, smoothed, and/or fused to adjoining layers by roller 59.

As mentioned above, CNC machine 1 may be controlled via a program, e.g. a print program to produce a part. The print program may be part of, or generated from, a slicing process.

The slicing process may receive a CAD model (or models) of the part to be printed and slice the part into sections having a plurality of layers, each section having their own print properties, for printing. The CAD model may be a 3D or 2D representation of the part to be printed. In some examples, the CAD model may include a model of an outside shape of the part and separate models of each interior structure of the part. The slicing process may simplify the CAD model which may allow the print process to be optimized. In some aspects of the present disclosure, the part is processed by the slicing process as multiple sections, each section having unique print parameters. These sections may be printed so that the individual sections or sections join together to form the part. The slicing process may assemble the sections and/or layers into a print program or process to manufacture the part to be printed. The slicing process may execute or transmit the print program to CNC machine 1 to print or otherwise manufacture the part.

The slicing process may be executed by a user via controller 100 of CNC machine 1 or an external computing device having a controller, e.g., a processor or microprocessor. Exemplary computing devices include, but are not limited to, a desktop computer or workstation, a laptop computer, a mobile handset, a personal digital assistant (“PDA”), a smart phone, a server, or any combination of these or other computing devices having a display, at least one controller (e.g. a processor or microprocessor), a memory, and one or more input devices. The user input device(s) may include any type or combination of input/output devices, such as, e.g., a keyboard, a touchpad, a mouse, a touchscreen, a camera, a stylus, and/or a scanner (e.g., a laser scanner).

The disclosed slicing process may include a user viewing, inputting, or otherwise executing the slicing process via a graphical user interface (“GUI” or “interface”) displayed by controller 100 (e.g., via display 101) and/or another electronic device. The interface may include one or prompts and/or other elements allowing or requesting that the user to input, select, or otherwise determine parameters of the slicing process. Prompts for user input may include, but are not limited to, links, buttons, images, check boxes, radio buttons, text boxes, and menus. As used herein, a print parameter referred to as “a selection” by the user may include the user selecting a value from a number of preset values, checking a check box, clicking a radio button, or otherwise making a selection using one or more prompts.

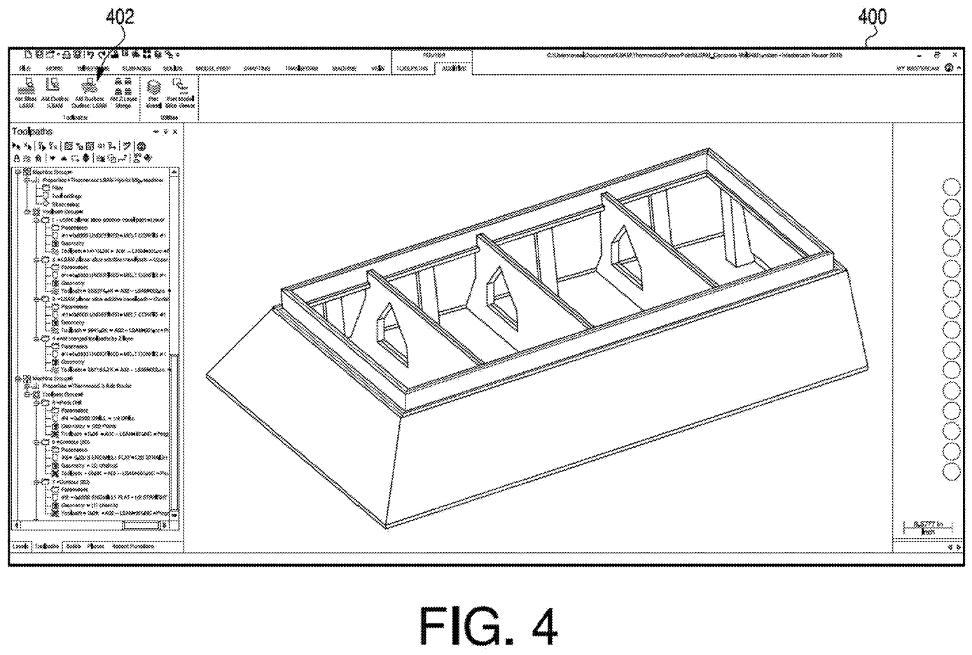

Turning now to FIG. 4, an interface 400 may present the user with a part model viewer and a part model slice viewer. The part model viewer may allow the user to digitally assemble a part model of the individual sections of a part to be printed, or of the whole part (e.g., including the individual sections merged together). The part model slice viewer may allow the user to view the CAD model slice-by-slice for each section or the part to be produced as a whole. Additionally, the part model slice viewer may permit the user to view a net model, a print tool path, or a physical print beads model of the section or part to be printed. The user may reference the print model viewer and/or the part model slice viewer before, during, or after executing the slicing process.

Interface 400 may include a prompt, e.g., an additive manufacturing toolbar 402, for a user to select a toolpath type and/or other parameters of the slicing and printing processes. The toolpath types may specify the slicing process corresponding to the CAD model(s). The toolpath types may further define how the CAD model(s) of the part to be printed are divided into sections, and how each section is further divided into layers via the slicing process. Exemplary tool path types may include an AM-Slice type, an AM Outline type, and an AM Surface Outline type. The AM-Slice toolpath type may specify that the slicing process includes dividing a CAD model of solids, surfaces, or polygonal mesh into cross sectional layers, each layer having a thickness determined in part based on the layer height (e.g., spacing) printing parameter. The AM Outline toolpath type may specify that the slicing process includes receiving a 2D line drawing of the part or section to produce a layer or multiple layers that follow the path of the line drawing. Using the AM Outline toolpath type, the total number of layers and layer height produced by the slicing process may be determined based a parameter input by the user. The AM Surface toolpath type may specify that the CAD model(s) include a 2D line drawing of the part or section, and that the drawing is divided into a layer or multiple layers that follow the path of the solids, surfaces, or polygonal mesh. The number of layers in height produced by the AM Surface Outline toolpath type may be determined based on a height of the section or part. Interface 400 may include an AM Z Merge selection for combining toolpaths. The AM Z Layer Merge selection may combine each of the different toolpaths (and their respective print parameters) as generated by the slicing process into a single printing process for all sections and/or layers of the part to be printed. Thus, the slicing process may receive electronic models, e.g., CAD models, having multiple types of geometries, such as, e.g., solids, surfaces, polygonal mesh, and 2D drawings to produce and/or execute a printing process for manufacturing the part.

Once the toolpath type has been selected, a category of print parameters may be selected. The categories of print parameters may include, but are not limited to, general, boundary, and fill. In some examples, the selected tool path type may determine the print parameter categories that may be defined by the user. For example, the AM Outline and/or AM Surface Outline may not include a fill category.

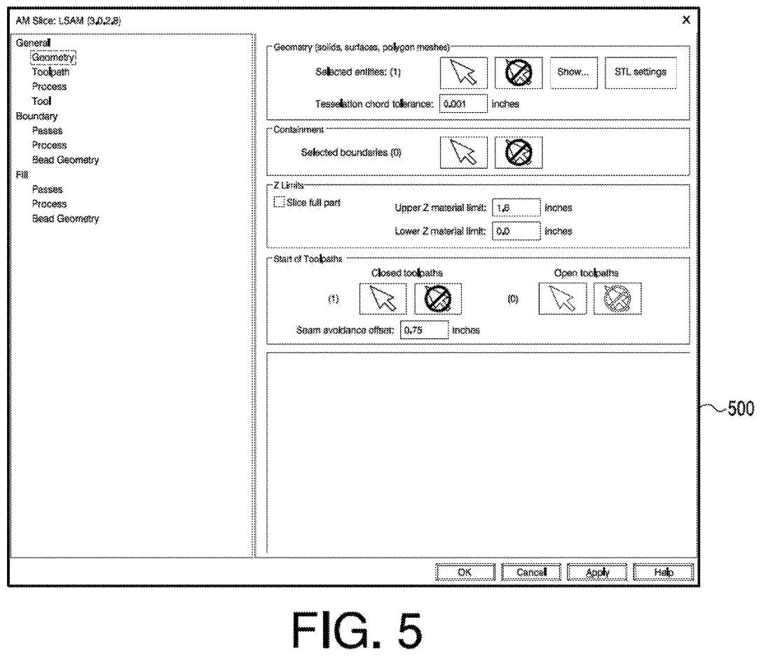

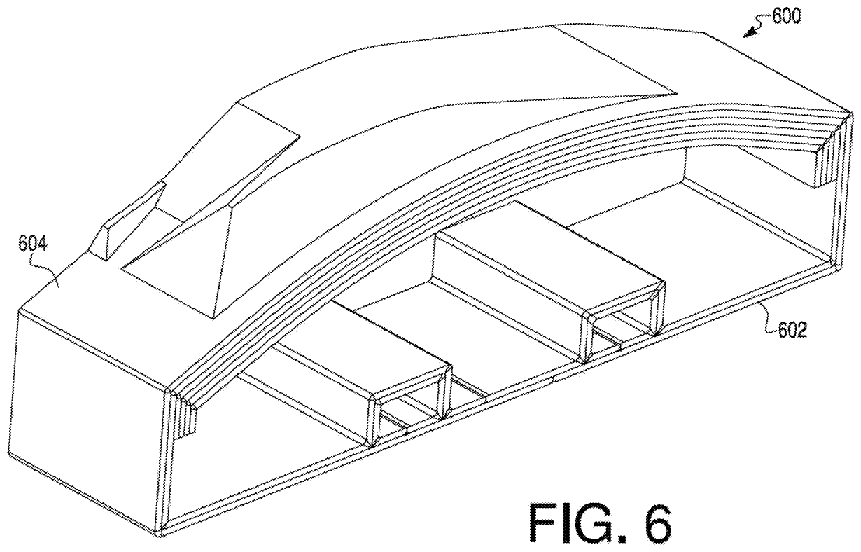

FIG. 5 depicts a user interface 500 prompting the user to input values or otherwise specify the print parameters of a geometry subcategory within the general category. The geometry subcategory may include print parameters such as a tessellation chord tolerance parameter, a containment boundaries parameter, a Z limits parameter, a toolpath start locations parameter, and a seam avoidance offset parameter. The tessellation chord tolerance parameter is a value indicative of the accuracy with which the toolpath follows the contour of the section or part. In some examples, the tessellation chord tolerance parameter may be changed or selected so as to smooth the toolpaths, e.g., by increasing the tessellation chord tolerance parameter. The containment boundaries parameter refers to an inside surface and an outside surface of the part. The area formed between the inside surface and the outside surface may be referred to as the “fill.” For example, a donut shaped section may include an inner circle corresponding to the inner surface (e.g., the hole), an outer circle circumferentially surrounding the inner circle and corresponding to the outer surface, and an area formed between the inner circle and the outer circle corresponding to the fill. In some examples, the containment boundaries may have different thicknesses in different areas. For example, with reference to FIG. 6, a part 600 may include a top side 604 having six boundary layers and a bottom side 602 including two boundary layers.

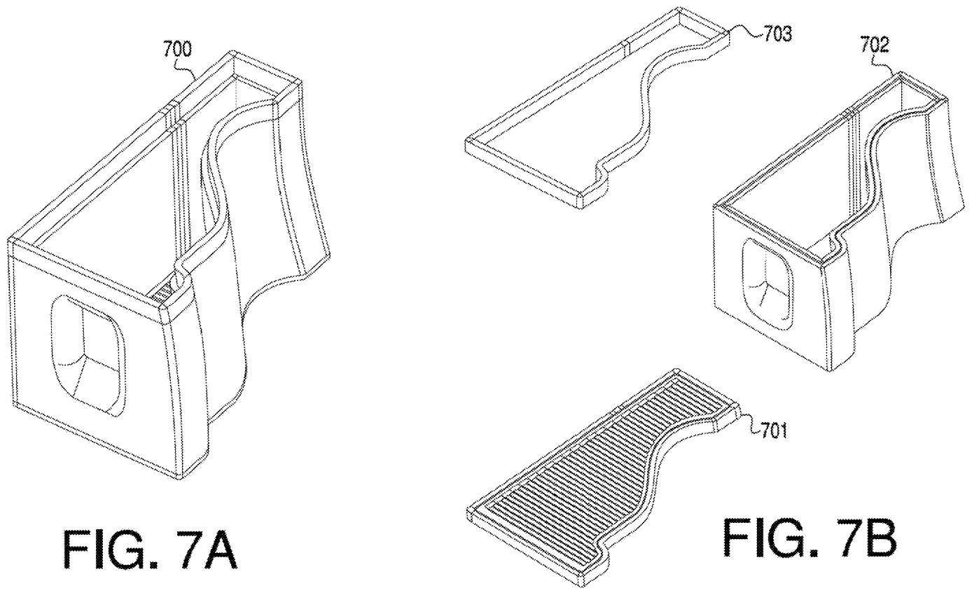

Turning back to FIG. 5, the Z Limits print parameters may include a lower Z material limit and an upper Z material limit. Additionally or alternatively, the interface may include a full part parameter which may be selected so that the lower Z material limit is set at a bottom surface of the section being printed and an upper Z material limit defined a distance from the bottom surface to a surface having the greatest height from the bottom surface. The distance between the lower Z material limit and the upper Z material limit may define a range of heights for which layers of the section may be determined by the slicing process. The Z limits print parameters may enable users to select an entire electronic model (e.g., CAD model/drawing) of a part or a section of the part defined between the lower Z material limit and the upper Z material limit for processing via the slicing process. For example, the section of the CAD model may be defined as any portion of the CAD model having a height above the worktable 27 that is 2 inches to 6 inches. Additionally or alternatively, the Z limit print parameters may be defined so that different printing parameters may be applied to separate heights of the same section. For example a part 700 shown in FIGS. 7A and 7B includes a bottom section 701, a middle section 702, and a top section 701, each section defined by Z limits print parameters of varying heights. Further, each of the bottom section 701, the middle section 702, and the top section 703 has different print parameters, e.g., different boundary layers and fill styles. The bottom section 701 has two boundary layers with a fill between the boundary layers. The middle section 702 has two boundary layers. The top section 703 has only one boundary layer.

With reference again to FIG. 5, the start point location set of print parameters may include an open toolpath parameter, a close toolpath parameter, and a seam avoidance offset parameter. The open toolpath parameter and the closed toolpath parameter allow the user to select geometry to define where the toolpath starts on any given layer. The seam avoidance offset parameter is a distance a start and a stop seam location are offset from one another between print layers.

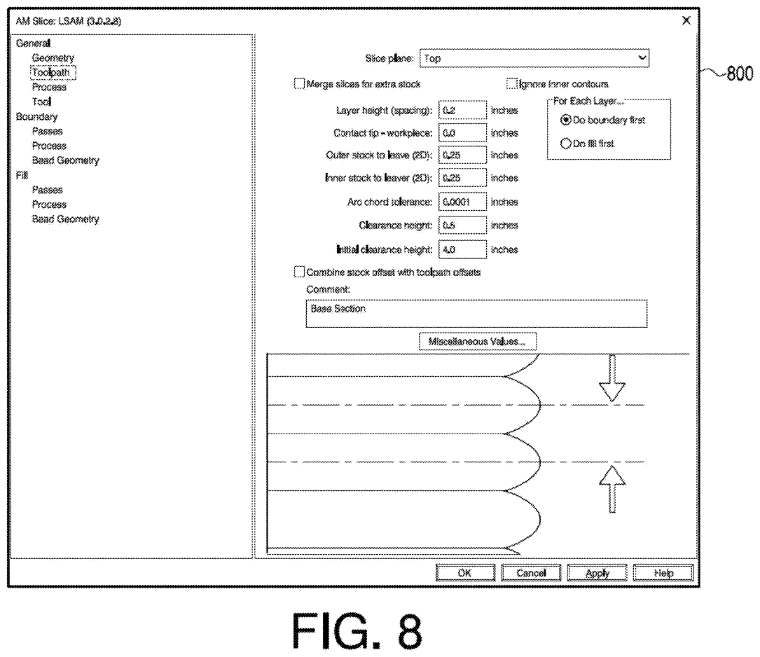

In addition to the geometry subcategory, the general category may include a toolpath subcategory. FIG. 8 shows an exemplary interface 800 through which a user may input values for the print parameters included in the toolpath subcategory. The toolpath subcategory may include print parameters or sets of print parameters such as, e.g., a slice plane parameter, a merge slices for extra stock parameter, an ignore inner contours parameter, a layer order parameter, a layer height (spacing) parameter, a contact tip-workpiece parameter, an outer stock to leave (2D) parameter, an inner stock to leave (2D) parameter, an arc chord tolerance parameter, a clearance height parameter, an initial clear height parameter, and a combine stock offset with toolpath offsets parameter. The slice plane parameter defines a plane from which the CAD model will be sliced. The slice plane parameter may be selected from a number of preset values, such as, e.g., top, side, etc.

Additionally or alternatively, the slice plane parameter may be determined by controller 100 or input by the user. The merge slices for extra stock parameter may compare an outline of a slice of a layer selected by the user (the “selected layer”) to an outline of a layer on which the selected layer will be applied (the “previous layer”) and an outline of a layer that will be applied on top of the selected layer (the “subsequent layer”). The merge slices for extra stock parameter may then select the outline having the greatest surface area among the selected layer, the previous layer, and the subsequent layer for use in producing the toolpath for the current layer. The ignore inner contours parameter may be a selection of whether or not the inner contours are removed from consideration during the slicing process. The layer order set of print parameters may be a selection of whether the boundary or fill of each layer is deposited first. The layer height (spacing) print parameter defines a measurement of a thickness of each layer to be produced by the slicing process. The contact tip-workpiece parameter is a distance above worktable 27 at which the applicator head 43 is positioned before beginning the printing process.

With continued reference to FIG. 8, the contact-tip workpiece parameter is measured relative to the Z limits. For example, if the lower Z material limit is defined as 2 inches, a value of −2 inches may be input to define the contact tip-workpiece print parameter to position the applicator head 43 on the worktable 27, instead of 2 inches above the worktable 27, when beginning the print process. The outer stock to leave (2D) parameter is a distance the bead being deposited is offset from an outside surface of the outside contour of the section being printed. The inner stock to leave parameter is a distance the bead being deposited is offset from an inside surface of the inside contour of the section. The arc chord tolerance parameter is a distance controlling the fit of the arcs of the applicator head 43 to the toolpath. In some examples, the arc chord tolerance parameter may be adjusted or selected to smooth out the toolpath. For example, decreasing the value of the arc chord tolerance may produce arcs over the toolpath having a smoother shape. The clearance height parameter is a height above worktable 27. The applicator head 43 moves to this height between printing separate layers. The initial clearance height parameter is a height above worktable 27 to which applicator head 43 moves before initiating the printing process. The combine stock offset with toolpath offset parameter is a selection that determines whether the distances of the stock offset and the toolpath offset are combined into a single value when executing the slicing process.

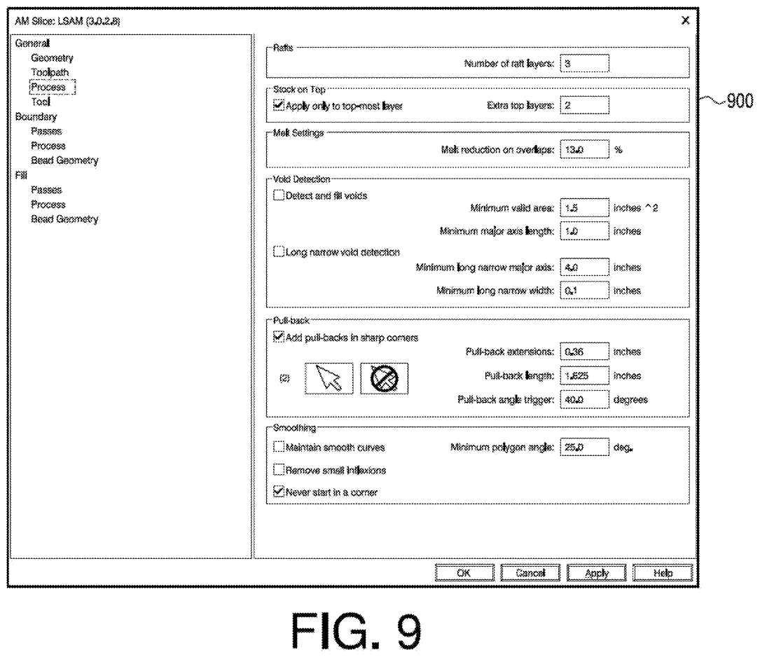

FIG. 9 depicts a user interface 900 that allows the user to input values or otherwise specify print parameters included in the process subcategory of the general category. Exemplary print parameters within the process subcategory include a rafts parameter, a stock on top parameter, a melt settings parameter, a void detection parameter, a pull-back parameter, and a smoothing parameter. The rafts parameter refers to a number of layers printed before the layers of the part or section being printed are deposited. For example, if the rafts parameter is a value of 2, the applicator head 43 will deposit 2 layers before depositing the first layer of the part or section being printed. The stock on top parameter is a number of layers printed on a top layer of the part or section or part being printed. The top layer is the layer having the greatest Z axis height of the part or section. The top layer does not refer to peak areas of the part or section, e.g., an area of a layer having a height less than another layer, wherein no layers are deposited on top of the area. For example, a part may have a middle layer below the top layer. The middle layer may include a peak, e.g., a portion of the middle layer where no material is deposited. In this example, the stock on top parameter defines the number of layers deposited only on the top layer even though no layers will be deposited on the middle layer at the peak. The melt settings parameter defines the percentage by which the speed of the gear pump (measured in RPM) is reduced on overlapping beads during operation of the CNC machine 1. The melt setting print parameter may be changed to reduce buildup from depositing one bead adjacent to the next. The void detection set of print parameters refer to parameters that define the fill for any voids detected during an analysis of the layers of the part or section performed during the slicing process.

The pull-back parameters include a selection of whether or not to take a pull-back process into account when executing the slicing process, and the corresponding parameters for that pull-back process. A pull-back process may be used to avoid removing excess material from corners of the part. In some examples, if a pull-back process is not used when printing a corner of a part the roller 59 may disengage from the bead. Then, when the roller 59 reengages with the bead, the roller 59 may inadvertently push material away from the corner. The pull-back length parameter is a distance from a corner at which the pull-back process may begin. Upon reaching the distance from the corner specified by the pull-back length parameter, the roller 59 may be moved away from the corner by the distance input for the pull-back extensions parameter. In some examples, pull-back may be referred to as “corner-pull-back.” The smoothing print parameters may include a maintain smooth curves parameter, a remove small polygons parameter, a never start in a corner parameter, and a minimum polygon angle parameter. The smoothing print parameters may alter or adjust the toolpaths of a part or section to smooth any curves.

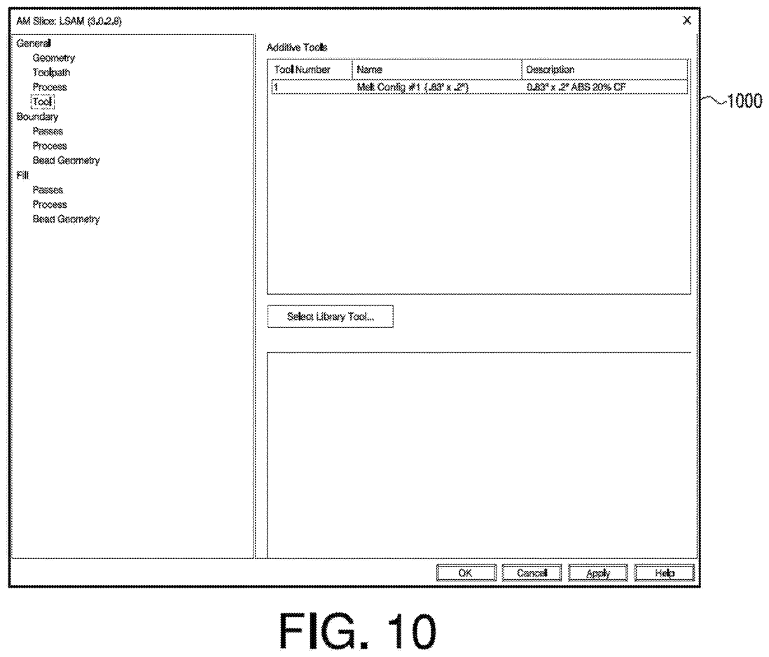

FIG. 10 depicts a user interface 1000 that allows the user to input values or otherwise specify the print parameters included in the tool subcategory under the general category. The tool subcategory may represent the melt configuration corresponding to the tool used in the printing process. For example, a melt configuration number 1 may correspond to a tool number 1, where melt configuration 1 is described as using a print material comprising 20% carbon fiber filled ABS, a print bead width of 0.83 inches and a print bead thickness of 0.20 inches.

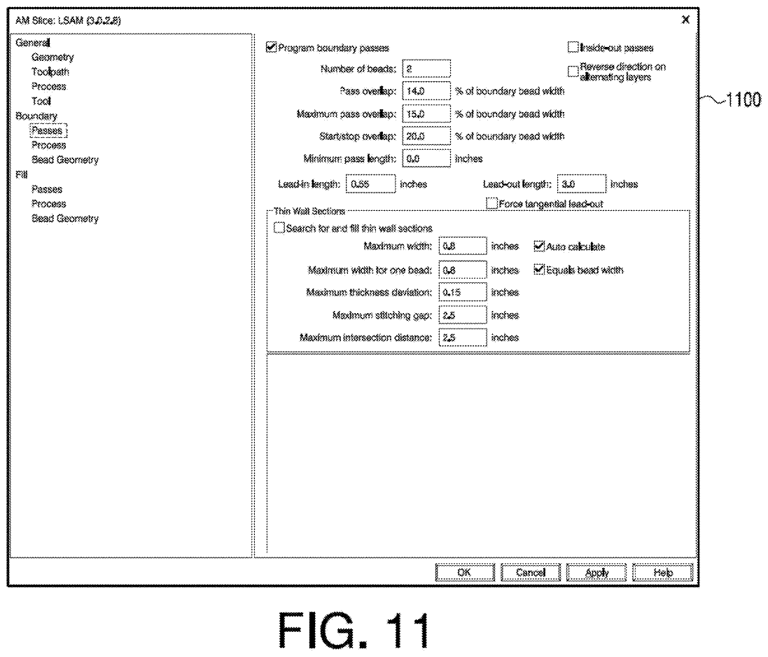

FIG. 11 depicts a user interface 1100 that allows the user to input, select, or otherwise specify the values of the print parameters included in the passes subcategory under the boundary category. The passes subcategory may include print parameters or sets of print parameters such as, e.g., a program boundary passes parameter, an inside-out passes parameter, a reverse direction on alternating layers parameter, a number of beads parameter, a pass overlap parameter, a maximum pass overlap parameter, a start/stop overlap parameter, a minimum pass length parameter, a lead-in length parameter, a lead-out length parameter, a force tangential lead-out parameter, and a thin wall sections parameter. The program boundary passes parameter refers a selection of whether or not the toolpath includes boundary passes. The inside-out passes parameter is a selection of whether or not the toolpath starts with an inner-most pass, determined with respect to the layer outline, and progress outwards towards the layer outline. The reverse direction on alternating layers parameter is a selection of whether or not the toolpath reverses direction for every other layer.

The number of beads parameter represents the number of toolpath passes to made by the applicator head 43 along each boundary of the layer outline. The pass overlap parameter specifies a value of the lowest percentage of overlap between adjacent beads (measured as a percentage of the bead width). The maximum pass overlap parameter refers to a maximum distance (measured as a percentage of the bead width) that adjacent print beads will overlap one another. The start/stop overlap parameter is a value corresponding to the percentage of overlap between the beginning and ending of the bead on boundary passes (measured as a percentage of bead width). The lead-in length parameter is a distance that the bead will be deposited along a layer before starting to deposit each boundary pass. The lead-out length parameter is a distance the bead will be deposited measured from the end of each boundary pass. The force tangential lead-out print parameter is a selection determining whether the bead moves tangentially to the toolpath upon completing the toolpath. The thin wall sections set of print parameters may include a maximum width parameter, a search for and fill thin wall sections parameter, a maximum width for one bead parameter, a maximum thickness deviation parameter, a maximum stitching gap parameter, a maximum intersection distance parameter, an auto calculate parameter, and an equals bead width parameter. As defined herein, a thin wall is a portion of a layer of the section or part being printing between two boundaries positioned close to one another. In other words, the two boundaries form a thin wall between them. The set of thin wall sections set of print parameters may be used to identify a thin wall area in a section or section and if and/or how such an area should be filled.

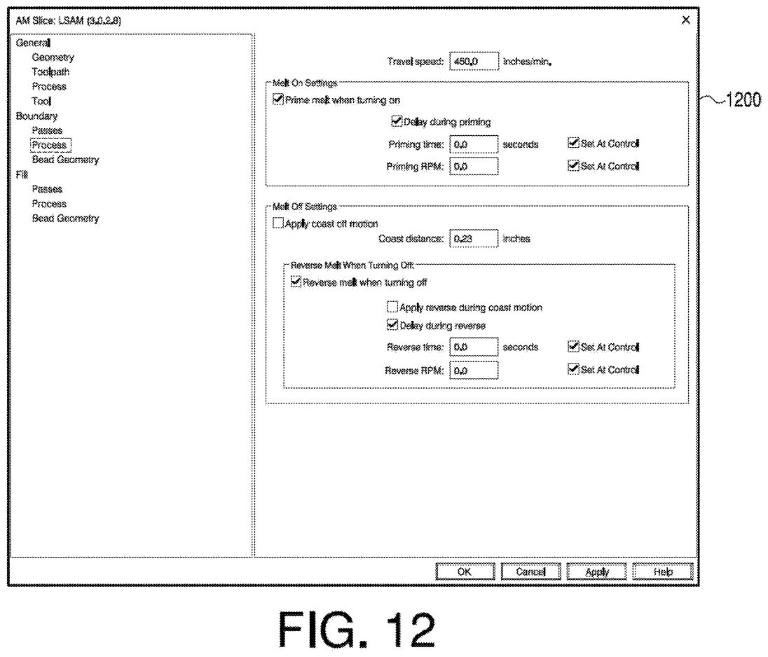

FIG. 12 depicts a user interface 1200 that allows the user to input values or otherwise specify print parameters included in the process subcategory under the boundary category. In some examples the process subcategory for the fill category include the same print parameters as the boundary category. The print parameters of the process subcategory may include a travel speed parameter, a melt on settings set of print parameters, and a melt off settings set of print parameters. The travel speed parameter is a maximum feed rate of the flowable material through the applicator head as it deposits material. The melt on settings set of print parameters may include a prime melt when turning on parameter, a delay during priming parameter, a prime time parameter, and a priming RPM parameter. The prime melt when turning on parameter is a selection of whether or not the priming process is executed before depositing each bead. The delay during priming parameter is a selection of whether or not the bead may be deposited along the toolpath during the priming process. The priming time parameter is period of time for which the priming process may be executed. The priming RPM parameter is a speed, measured in revolutions per minute, at which the extruder 61 rotates the extruder screw during the priming process.

The melt off settings set of print parameters may include an apply coast off motion parameter, a coast distance parameter, a reverse melt when turning off parameter, an apply reverse during coast motion parameter, a delay during reverse parameter, a reverse time parameter, and a reverse RPM parameter. The melt off settings set of parameters control the extrusion and/or deposition of material during a “coast process” executed at the end of printing each bead. The apply coast off motion parameter is a selection of whether or not the extruder continues to melt the material while the applicator head 43 moves through distance specified by the coast distance parameter. The coast distance parameter a distance, measured from the end of each bead, that the applicator head 43 moves while executing the coast process. The reverse melt when turning off parameter is a selection of whether or not the to reverse the flow of material during the coasting process. The flow of material may be reversed while the applicator head 43 moves through the coast distance, or while the applicator head 43 stays in place. In some examples, the flow may be reversed by rotating the extruder screw and/or the gear pump 62 in a direction opposite to the direction of rotation for printing. Reversing the flow of material may, in some embodiments, pull material into one or more parts of CNC machine 1, e.g., the extruder 61 or the applicator head 43.

The apply reverse during coast motion parameter is a selection that controls whether the reversal of the flow of the material is reversed while the applicator head 43 moves through the coast distance. The delay during reverse parameter is a selection determining whether the reversal of the flow of the material is time bound by the reverse time parameter. The reverse time parameter is a period of time that the flow is reversed during the coasting process. The reverse RPM parameter is a speed (measured in revolutions per minute) that the extruder screw is rotated when the flow of the material is reversed. The set at control parameter is a selection of whether or not the priming time parameter, the priming RPM parameter, the reverse time parameter, or the reverse RPM parameter may be overridden by the slicing process and replaced with values received via command codes determined by the controller 100.

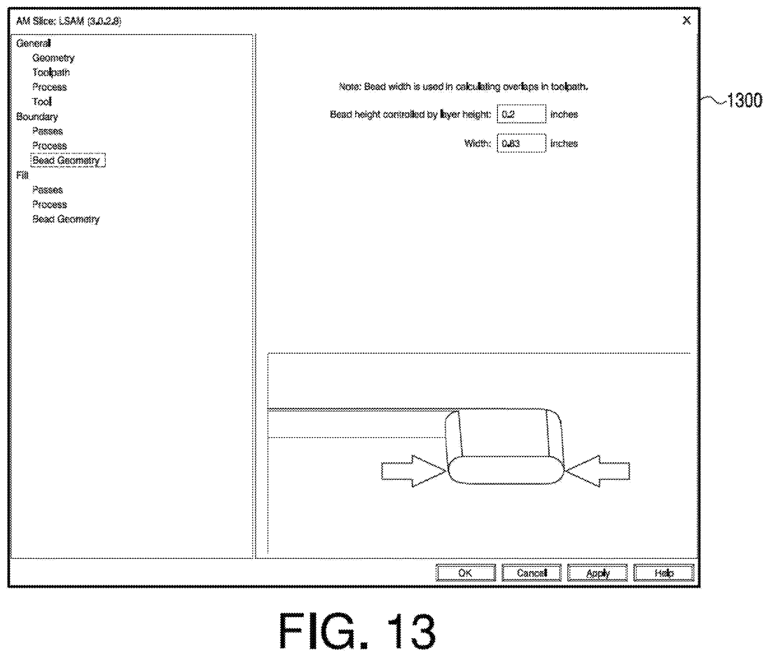

FIG. 13 depicts a user interface 1300 that allows the user to input values or otherwise specify the print parameters included in the bead geometry subcategory under the boundary category. In some examples, the bead geometry subcategory under the fill category may include the same print parameters as the geometry subcategory of the boundary category. The parameters listed on this subcategory may include a bead height controlled by layer height parameter and a width parameter.

The bead height controlled by layer height parameter is a thickness of each bead being deposited to form each layer of the section or part. The bead height controlled by layer height parameter may be determined based in part on the layer height parameter of the toolpath subcategory of the general category. The width parameter is a measurement of a width of the bead to be deposited. The width parameter may be used to generate the toolpath and/or simulate the printing process. As mentioned above, one or more of the print parameters may be determined based in part on the value of the width parameter.

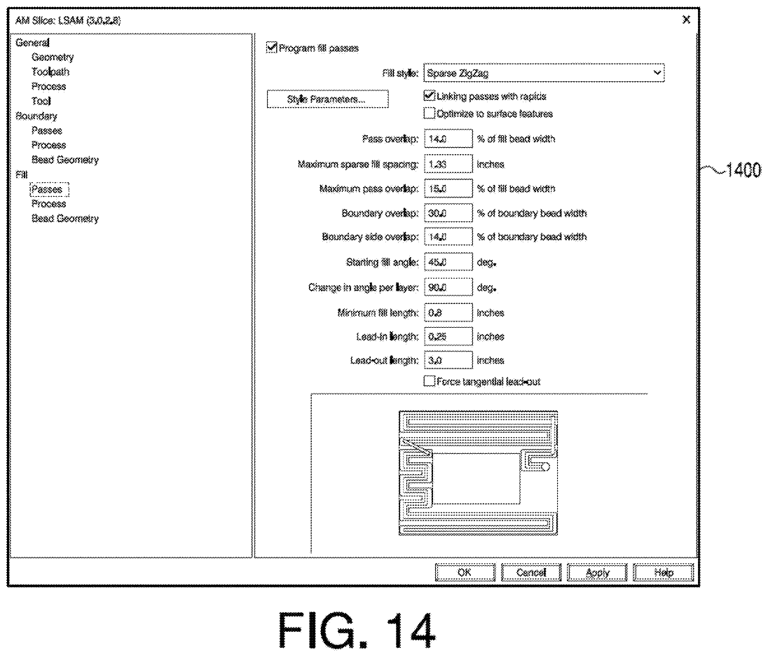

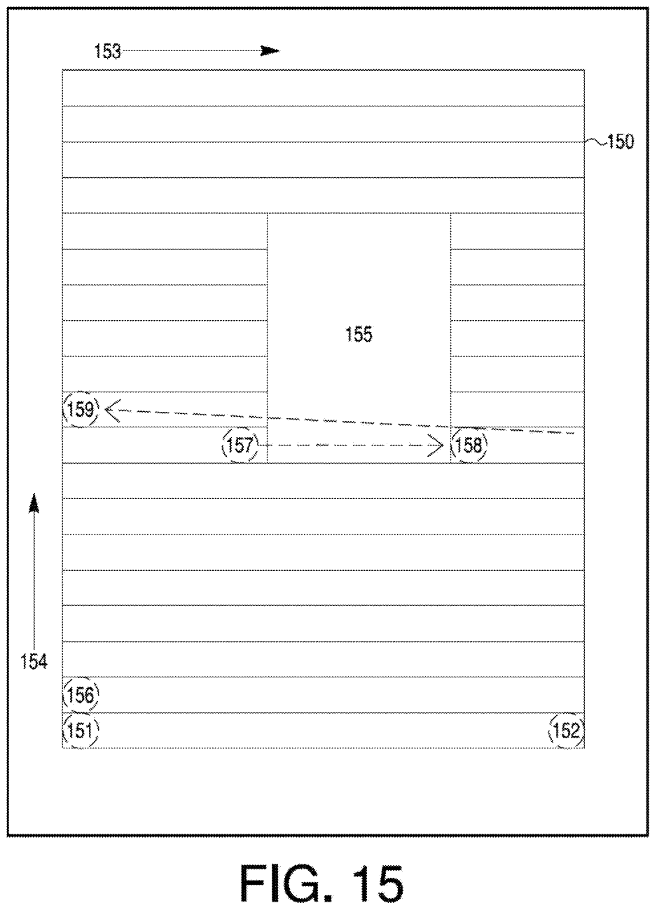

FIG. 14 depicts a user interface that allows the user to input values or otherwise specify the print parameters included in the passes subcategory under the fill category. The passes subcategory may include print parameters such as, e.g., a program fill passes parameter, a fill style parameter, a linking passes with rapids parameter, an optimize to surface features parameter, a pass overlap parameter, a maximum sparse fill spacing parameter, a maximum pass overlap parameter, a boundary overlap parameter, a boundary side overlap parameter, a starting fill angle parameter, a change in angle per layer parameter, a minimum fill length parameter, a lead-in length parameter, a lead-out length parameter. The program fill passes print parameter is a value indicating a selection of whether or not the toolpath will be determined with a fill. The fill style parameter is a selection of the method of determining the toolpath for the fill. Exemplary fill styles include a simple zigzag style, a smart zigzag style, a smart zigzag constant overlap style, a variable bead regions style, a sparse zigzag style. These exemplary fill styles are illustrated in FIGS. 15 through 19, which will now be described.

FIG. 15 depicts a top view diagram of the toolpath of a layer 150 produced using the one way fill style. The one way fill style may produce a toolpath having lines all oriented along the same direction. The toolpath begins by depositing a bead in a first pass starting at a first point 151 moving along a first vector 153 toward a second point 152. Upon reaching point 152, the applicator head 43 stops depositing the bead, and moves to a third point 156 adjacent to the start of the first pass, at first point 151. The bead then deposits a second pass from the third point, the second pass extending along the first vector 153 adjacent to the first pass. These steps are repeated to deposit additional passes, each subsequent pass being depositing along the first vector 153 adjacent to the preceding pass. Accordingly, a width of each pass of the toolpath increases a width of the layer 150 along a second vector 154. If the applicator head 43 encounters a hole 155 in layer 150, e.g., at point 157, the applicator head 43 stops printing the bead and moves to a position across the hole 155 opposite of point 157, point 158,. The applicator head 43 then continues to deposit the printing bead along the first vector 153. Once the pass containing points 157 and 158 is completed, the applicator head 43 moves to a position 159 adjacent the start of the pass that contains points 157 and 158. The applicator head 43 continues to deposit the printing bead in this manner until the layer 150 is complete.

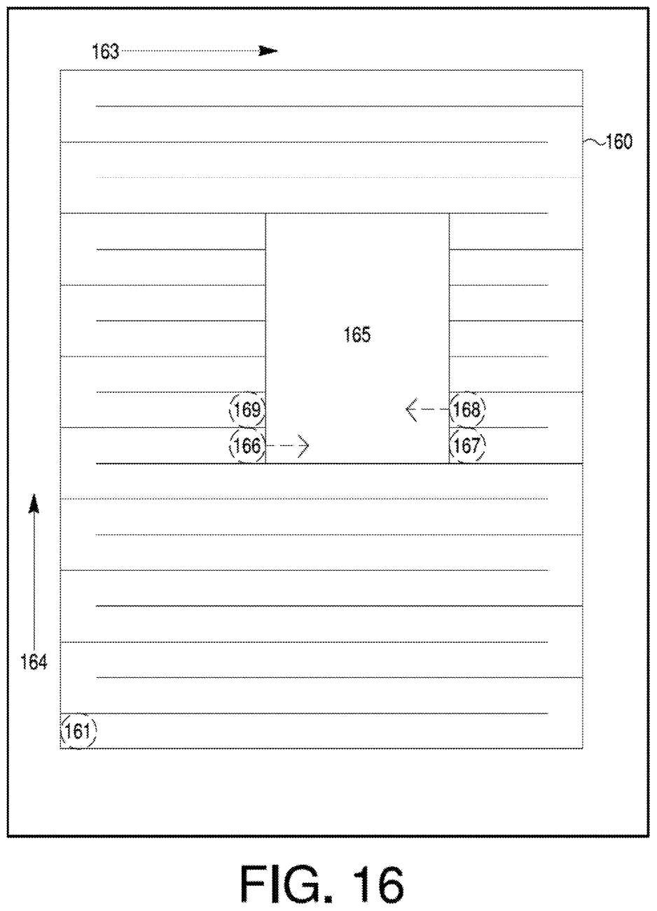

FIG. 16 depicts a top view diagram of the toolpath of a layer 160 generated using the simple zigzag fill style prints. The simple zigzag fill style may produce a toolpath that serpentines along the layer to fill the layer. For example, the toolpath may begin a first pass at a first point 161 and extend along a first vector 163. Upon reaching a boundary of the layer 160, the first pass may be completed, but the bead may still be deposited as the applicator head 43 moves along a second vector 164 a distance equal to the width of the bead being deposited along the tool path. The toolpath then begins a second pass, guiding the applicator head 43 in a direction opposite the first vector 163 till it reaches another boundary of the layer. By these steps, the bead is deposited in a serpentine manner in which each subsequent pass extends adjacent to the preceding pass in a direction opposite the preceding pass. If the toolpath encounters a hole 165 in the layer 160, e.g., at a second point 166, the applicator head 43 stops depositing the bead and continues to follow the current pass direction over the hole till the applicator head 43 has completely passed over the hole, e.g., at a third point 167. The applicator head 43 then begins depositing the bead of material from the third point 167 in the same manner as the previous passes. The steps of stopping the printing of the bead and moving over the hole 165 may be repeated for any additional points where the toolpath intersects the hole 165, e.g., from a fourth point 168 to a fifth point 169.

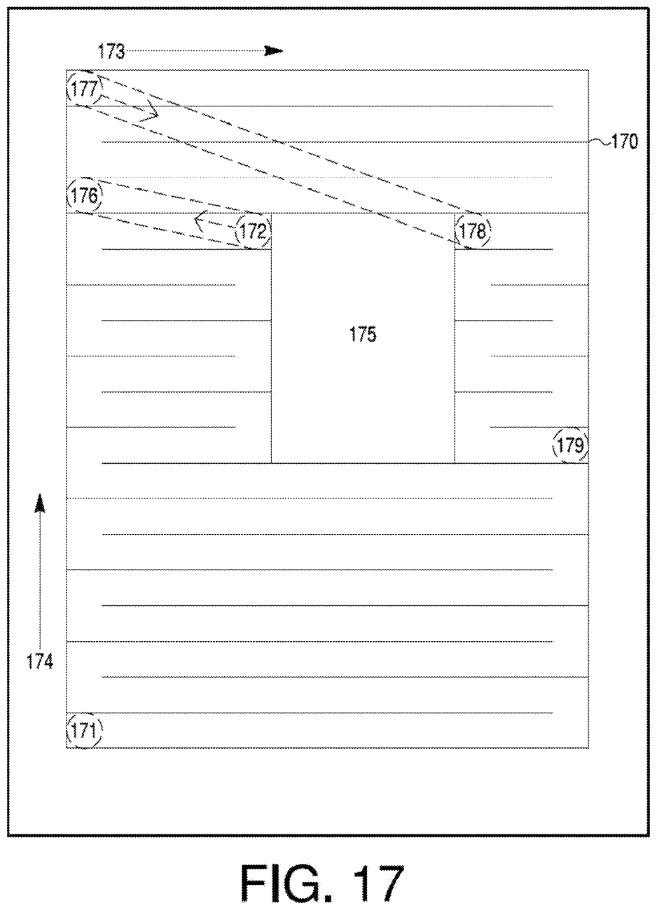

FIG. 17 depicts a top view diagram of the toolpath of a layer 170 generated using the smart zigzag fill style. The toolpath generated using the smart zigzag fill style is generated in a manner similar to the simple zig zag fill style. For example, a first pass may begin at a first point 171 and extend along a first vector 173. The toolpath may serpentine through the layer 170 along a second vector 174 while continuously depositing material. Using the smart zigzag fill style, if the toolpath intersects a hole 175 the applicator head 43 will continue to serpentine along the second vector 174 without passing over the hole 175 until the toolpath reaches a second point 172, where the toolpath intersects the hole 175 along the pass furthest along the second vector 174. At the second point 172, the applicator head 43 may stop depositing material and move to a third point 176 adjacent to the start of the most recent pass that intersected the hole 175. After reaching an end point of the layer 170 along the second vector 174, e.g., at a fourth point 177, the applicator head 43 stops depositing material and moves to a point along the last path that intersected the hole 175. This fifth point 178 is opposite the second point 172. From the fifth point 178, the toolpath may serpentine between the hole 175 and the outline of the layer 170 in a direction opposite to the direction of the second vector 174. The toolpath continues until it reaches a sixth point 179 where the next would intersect a previously deposited pass.

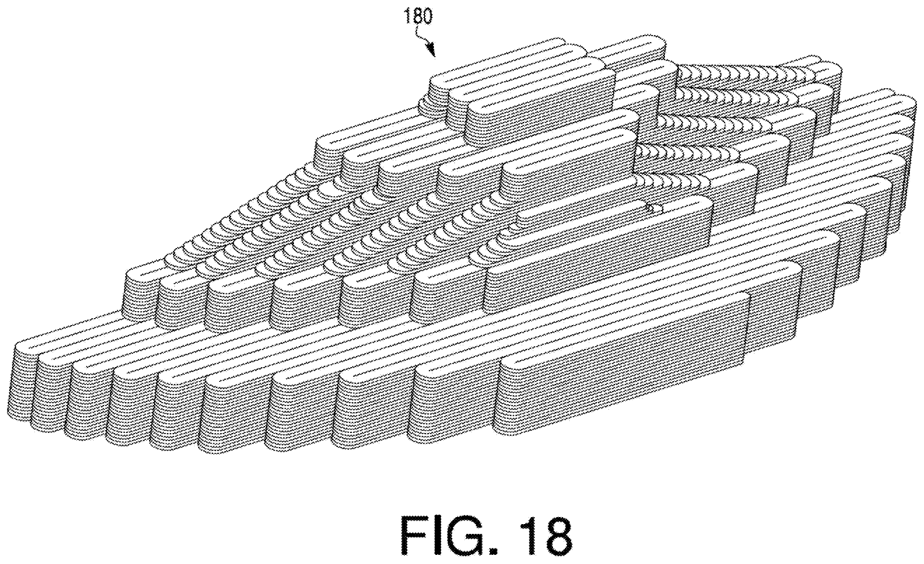

FIG. 18 illustrates a part 180 manufactured using the constant overlap fill style. The constant overlap fill style produces a toolpath in the same general manner as the smart zigzag fill style. However the constant overlap fill style creates a toolpath having a constant percentage, measured with respect to the bead of material, of overlap between passes of the toolpath. In some examples, sections or parts, e.g., sections or parts without a cavity or hole therein, may be printed with a toolpath limited to the fill of the part. In further examples, sections or parts may be printed from toolpaths absent boundary beads.

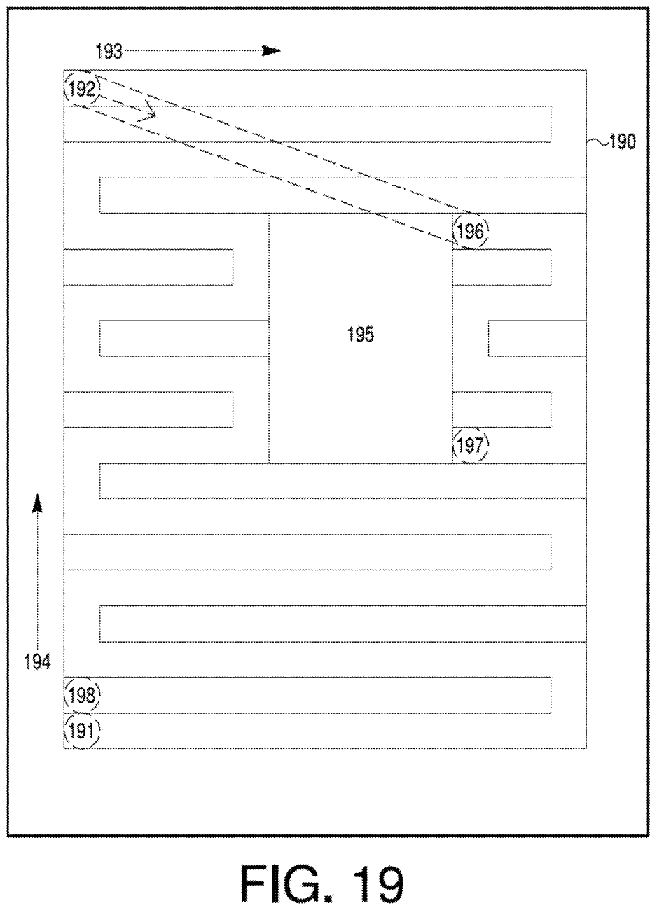

FIG. 19, illustrates a top view diagram of the toolpath of a layer 190 generated using the sparse zigzag fill type. Under the sparse zigzag fill type, a first pass may begin at a first point 191 and extend along a first vector 193. The toolpath may serpentine across the layer 190 in the direction of a second vector 194. As shown, the serpentine shape of the toolpath may leave a space between curves of the toolpath. If the toolpath intersects a hole 195 the toolpath will continue to serpentine along the second vector 194 between the hole 195 and a boundary of the layer. The toolpath continues along the layer in the direction of the second vector 194 until reaching an second point 192. Upon reaching the second point 192, the toolpath may instruct the applicator head 43 to stop depositing material and move to a space on the layer that has not yet been filled, e.g., a third point 196. The toolpath may include directions to deposit material from the third point 196 and move the applicator head 43 in along a direction opposite the second vector in a serpentine manner till the toolpath reaches a fourth point 197. The fourth point 197 may be a position adjacent to a bead of material that has already been deposited along the toolpath. The toolpath may further include one or more passes along any spaces or gaps between the curves of the toolpath, e.g., a pass beginning at a fifth point 198.

The variable bead regions fill style (not shown) may include determining a toolpath in a similar fashion to the smart zigzag tool type, the toolpath being altered to include an extra pass to fill any voids detected between the bead of the fill and a boundary of the layer.

With reference again to FIG. 14, the linking passes with rapids parameter a selection that determines whether the material is still melted, e.g., by operating the extruder 61, when the applicator head 43 moves from one fill line or pass to the next. Optimize to surface features is a selection of whether or not the toolpath is generated weighing accuracy of adhering to the contours of the part over reducing overlap between beads. The pass overlap parameter is a minimum percentage that the bead being deposited will overlap adjacent beads that have already been deposited as determined as a percentage of the width of the bead of the boundary. The maximum sparse fill spacing parameter is a maximum distance allowed between a center of one bead to the center of the adjacent bead when using the sparse zigzag fill style. The maximum pass overlap parameter is a maximum allowed percentage, measured with respect to the width of bead of the fill, that the bead can overlap adjacent beads. The boundary overlap parameter is a percentage, measured with respect to the bead width of the boundary, that each bead of the fill near the periphery of the layer may overlap the boundary beads of the layer. The value of the boundary overlap parameter may be input as a percentage of the width of the bead of the boundary. The boundary side overlap parameter is aa percentage measured with respect to the bead width of the boundary, that each bead of the fill that contacts the boundary will overlap the bead of the boundary. The starting fill angle parameter is an angle of the initial fill layer. The change in angle per layer parameter is angle the subsequent fill layer will be printed on with respect to the previous fill layer. The minimum fill length parameter is a minimum distance the toolpath must extend to be included as a fill pass. The lead-in length parameter is a distance used to approach the start of each fill pass. The lead-out length print parameter is a distance that the bead of the fill is deposited extending from the end of each fill pass along the toolpath. The force tangential lead-out is a distance the bead of the fill will extend tangentially from the last point in the toolpath.

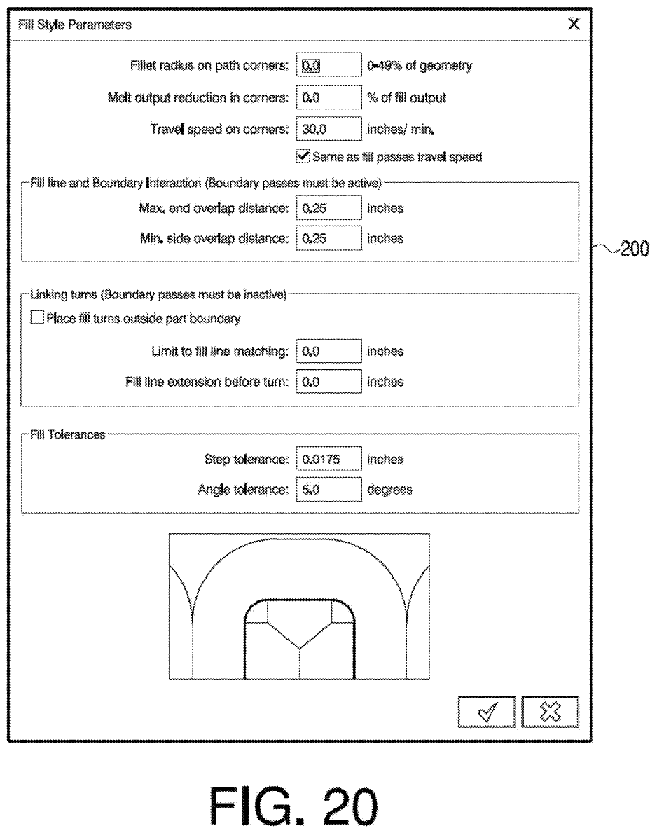

FIG. 20 depicts a user interface 200 that allows the user to input values or otherwise specify the print parameters included in the fill style print parameters subcategory. The parameters listed on the fill style print parameters subcategory may include a fillet radius on path corners parameter, a melt output reduction in corners parameter, a travel speed on corners parameter, a max end overlap distance parameter, a max side overlap distance parameter, a place fill turns outside section boundary parameter, a limit to fill line matching parameter, a fill line extension before turn set of parameters, a step tolerance parameter, and an angle tolerance parameter. The fillet radius on path corners parameter is a percentage of a radius of the bead at each corner of toolpath within the fill. The melt output reduction in corners parameter is a percentage of reduction of material being output in corners. The travel speed on corners parameter is a speed the nozzle 51 travels in the corners which can be made to match the fill pass speed by checking the parameter same as fill passes travel speed. The max end overlap distance parameter is a maximum distance the end of a fill bead can cross into a boundary bead and is used in conjunction with boundary overlap. The max side overlap distance parameter is a maximum distance the side of a fill bead can cross into a boundary bead and is used in conjunction with boundary side overlap. The place fill turns outside part boundary parameter is a selection to determine whether the toolpath line extends beyond the fill boundary at turns of the toolpath. When no boundary passes are included, if the two fill lines involved in a bridge do not form a perpendicular bridge, the shorter fill line is extended to be even with the longer fill line. If the difference in the two fill line end points is greater than the limit to fill matching value, the shorter fill line will not be extended and no bridge will be formed.

With continued reference to FIG. 20, the fill line extension before turn option allows the ends of each fill pass to be extended by a distance beyond the part boundary. The step tolerance parameter is a distance that is referenced for scale when determining the fill of small entities at a top and a bottom of a fill surface. The angle tolerance parameter is an angle indicative of the margin of error in creating a flat surface, e.g., the top surface and bottom surface of the fill surface.

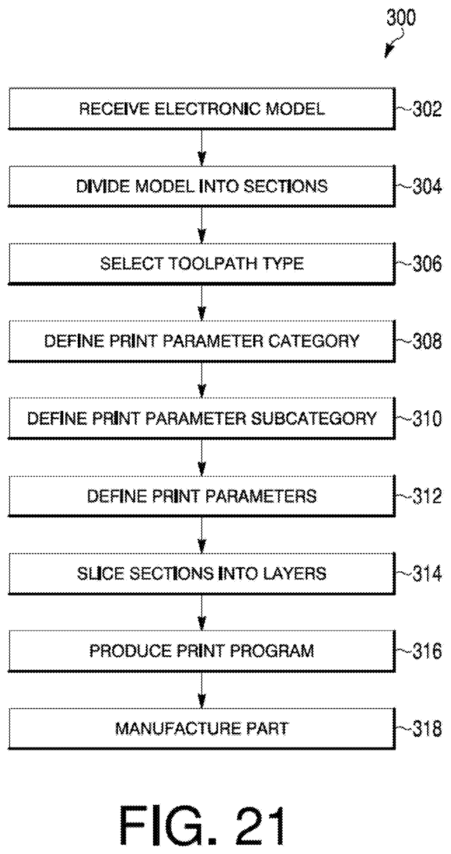

Based in part on one or more of the foregoing print parameters, the slicing process may divide an electronic model(s), e.g., a CAD model, of the part to be printed into a number of sections, each section having one or more layers, and each layer having a distinct toolpath and print parameters. The slicing process may produce a print program or process based in part on the sections and/or layers. The print program may be transmitted to CNC machine 1 to manufacture the part. FIG. 21 shows an exemplary flow diagram of a method 300 of executing the slicing process and manufacturing a part. The slicing process may include receiving an electronic model, such as, e.g., a CAD model, at an electronic device (e.g., at controller 100) at a step 302. Next, at a step 304, the model may be divided into a number of sections. Before slicing each section into layers, the parameters for printing those layers may be input, selected, adjusted, or otherwise specified by a user and/or retrieved from memory by the slicing process. To begin defining the parameters of each section, a toolpath type may be selected at a step 306. Next, at a step 308, a category of print parameters may be defined. Then, a subcategory of print parameters may be defined at a step 310. At step 312, one or more print parameters for the section may be defined. Steps 308, 310, and 312 may be repeated as desired to define print parameters under different categories or subcategories and/or print parameters of different sections. At step 314, the slicing process may slice or divide the sections into a number of layers. At step 316, the slicing program may produce a printing program or process to be executed at the CNC machine 1. The printing program may include some or all of the layers and sections of the part to be manufactured. Then, at step 318, the slicing process may initiate manufacturing of the part. The method 300 shown in FIG. 21 is only exemplary. Some of all of the steps of method 300 may be completed. Additionally or alternatively, the steps of method 300 may be executed in a different sequence.

### Automatic Brace Generation (“Autobracing”) in Additive Manufacturing Control Systems

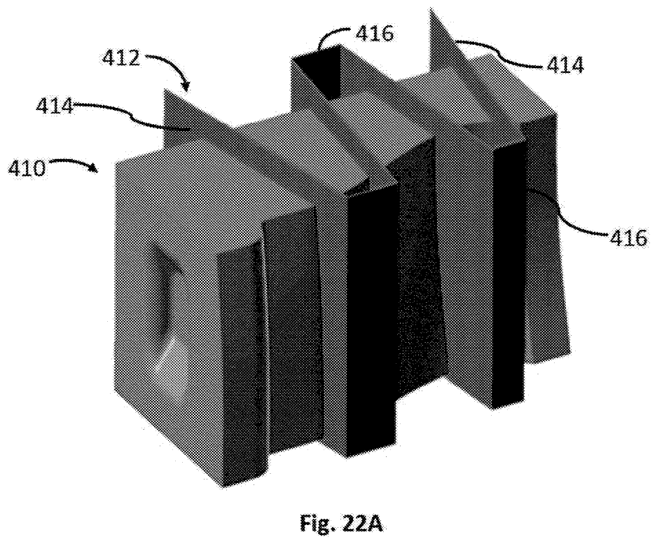

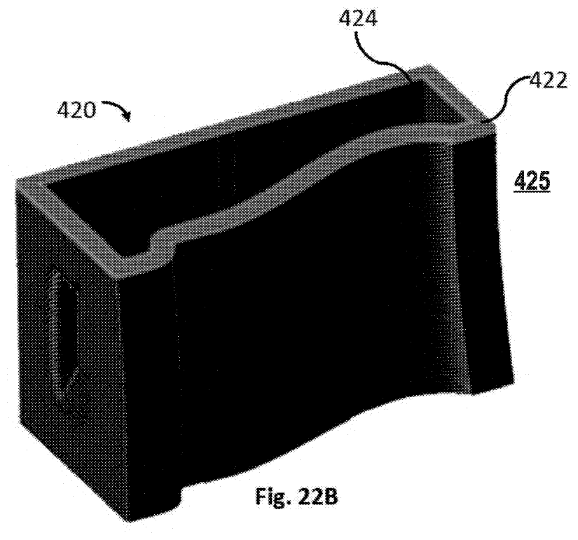

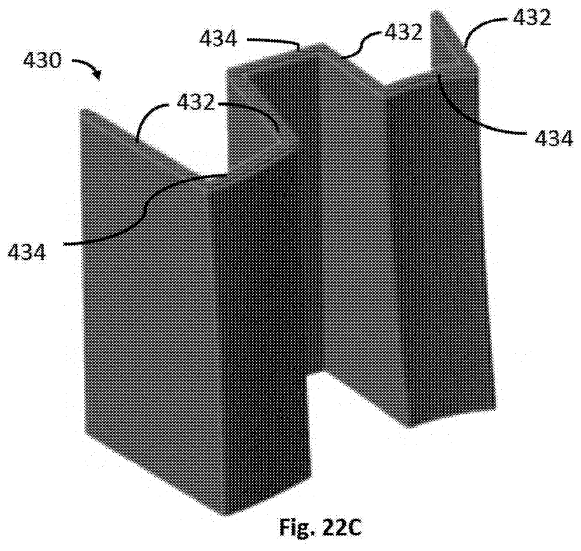

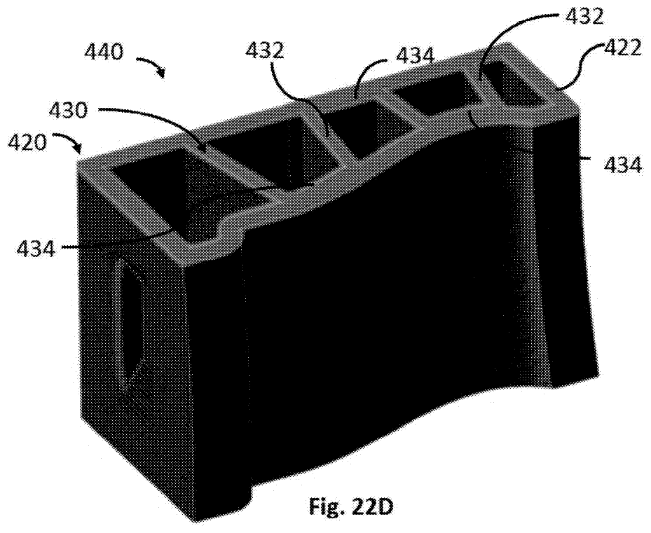

FIGS. 22A-22D show brace structures for parts that may be formed with the systems and methods described herein, including parts formed with an additive manufacturing apparatus such as CNC machine 1, described above. In particular, FIGS. 22A-22D show a model 410 (FIG. 22A), a boundary geometry 420 (FIG. 22B), a brace geometry 430 (FIG. 22C), and a part 440 (FIG. 22D) that includes boundary geometry 420 and brace geometry 430. These features and finished part (e.g., part 440) may be produced using the above-described additive manufacturing control system or another suitable system configured as described below.

FIG. 22A shows a view of a model 410 that may be used as an input to controller 100 (FIG. 1) and/or electronic information that is processed with controller 100 to form braces as described below. Model 410 may be a solid model used as an input or a target for an additive manufacturing process. Model 410 may correspond, for example, to the electronic model received in step 302 of method 300 (FIG. 21), as described above.

Model 410, once input, may be processed with controller 100. This processing may include generating one or more brace shapes, such as brace shape 412 shown in FIG. 22A. Brace shape 412 may be generated automatically with controller 100, or in response to a user input requesting generation of a brace shape. Brace shape 412 may be generated according to one or more print parameters that are input by a user or otherwise received with controller 100.

Brace shape 412 may form a geometry (e.g., points in three-dimensional space, such as points that are represented with Cartesian coordinates via controller 100) that is generated in addition, or in supplement, to the geometry of model 410. Brace shape 412 represents electronic model features that are added to model 410. In the illustrated example, brace shape 412 includes a series of transverse walls 414. Transverse walls 414 may extend at an angle other than 90 degrees with respect to the outer boundary of model 410. Walls 414 may extend linearly or substantially linearly and may be connected to each other via a series of connecting walls or connectors 416. In the illustrated example, an entirety of each connector 416 is located outside of model 410, while a portion of each transverse wall 414 is located within the interior of model 410.

In some aspects, brace shape 412 may be set based on one or more print parameters. These print parameters may specify, for example, a number of transverse walls 414 (e.g., a number of passes that brace shape 412 makes through model 410, four passes being shown in FIG. 22A), a distance between adjacent transverse walls 414, an angle formed at the intersection of each transverse walls 414 and a connector 416, a length of transverse walls 414, a length of connectors 416, and others. As shown in FIG. 22A, brace shape 412 includes portions that are inside of model 410 and outside of model 410.

FIG. 22B shows a view of a boundary geometry 420 that is determined based on analysis of model 410 with controller 100. As shown in FIG. 22B, boundary geometry 420 may be defined as a plurality of stacked layers that can be formed with CNC machine 1 or another additive manufacturing apparatus. The illustrated layers represent an entirety of the layers of model 410 or a subset of the layers of model 410.

Boundary geometry 420 may correspond to the outer-most portion (e.g., outer-most bead of thermoplastic material) of model 410 and may be defined by a perimeter 422. Perimeter 422 may define an interior 424 of 410, which may be hollow. Perimeter 422 may also define an exterior 425 that surrounds perimeter 422. In some aspects, perimeter 422 may correspond to the actual perimeter of model 410, such that the outer edge of perimeter 422 corresponds to the outer edge of model 410.

FIG. 22C illustrates a brace geometry 430 that is determined based on brace shape 412 and boundary geometry 420. Brace geometry 430 may also be defined by a series of layers that represent layers that may be physically formed with an additive manufacturing apparatus such as CNC machine 1.

Brace geometry 430 may include a plurality of brace walls 432 that are connected by a series of connectors 434. Each brace wall 432 may correspond to the portion of each transverse wall 414 (FIG. 22A) that is located within interior 424 of boundary geometry 420 (FIG. 22B). Therefore, some or all brace walls 432 may be shorter, in length, than transverse walls 414 (FIG. 22A).

If desired, brace geometry 430 may be displayed to a user and modified manually via interaction with a user input device for controller 100 or a separate computing system. For example, a user may alter the shape or position of one or more elements of brace geometry 430, input or change print parameters, or otherwise modify brace geometry 430. For example, a user may change the offsets (e.g., spacing) of brace walls 432, combine brace walls 432, etc. These modifications may be input with input portion 102 (FIG. 1)

The system, e.g., via controller 100, may generate connectors 434 to connect brace walls 432 together, e.g., in an end-to-end manner as shown in FIG. 22C. In some examples, connectors 434 are generated outside of perimeter 422 (FIG. 22B) and may be removed at later stages of the process for forming a brace, as described below.

In other examples, connectors 434 may be formed at locations where brace walls 432 intersect with perimeter 422 (FIG. 22B). For example, each connector 434 may be generated at the point where a first wall 432 intersects perimeter 422.

Each connector 434 may extend parallel to the corresponding portion of perimeter 422 until reaching a second wall 432. Thus, when a portion of perimeter 422 between two adjacent walls 432 is angled or curved, the corresponding connectors 434 may have a similar or the same angle or curvature. This curvature is shown in two of the three connectors 434, the two lower connectors 434 as shown in FIG. 22C. An upper connector 434 in FIG. 22C extends linearly in a manner that is parallel and that abuts the corresponding portion of perimeter 422.

FIG. 22D illustrates a complete part 440. Part 440 may be an electronic representation of the part that will be made when controller 100 controls servomotors or other components of CNC machine 1 to deposit material with nozzle 51, as described above. Part 440, as shown in FIG. 22D, may also correspond to the physical part that is itself manufactured according to the discussion of FIGS. 22A-22D. If desired, part 440 may also include a top layer (not shown) closing the upper opening shown in FIG. 22D. As understood, part 440 may also represent modifications made to model 410 (e.g., by adding braces to geometry 420).

As also shown in FIG. 22D, part 440 includes boundary geometry 420 and brace geometry 430. In at least some aspects, boundary geometry 420 provides structural reinforcement to part 440. For example, brace walls 432 may extend obliquely and connect two opposite ends of perimeter 422 of part 440. Part 440 may be reinforced by the ability of brace walls 432 to distribute stress in a printed part 440. Connector 434 may also provide reinforcement to boundary geometry 420. For example, each connector 434 may form an area of increased thickness and may double the thickness of complete part 440. In other aspects, connector 434 may be partially merged with perimeter 422, such that the thickness of part 440 at connectors 434 may be 75% greater (or more), 50% greater, or 25% greater (or less) than areas of perimeter 422 where no connector 434 is present.

As described above, one aspect of the disclosure that is represented in FIGS. 22A-22D depicts solid model 410 as the input or target for the slicing operation performed with slicing software. The corresponding output, boundary geometry 420, is shown as a series of boundary passes. In this example, the brace shape 412 is employed to produce the brace geometry 430, shown as a series of brace passes. The finished part 440 is produced by the slicing operation and is represented by a combination of all passes (e.g., of an additive manufacturing machine operating as described above).

The slicing techniques described herein may be performed in an additive manufacturing slicing operation (e.g., AM-Slice or a similar system) that samples 3D objects (e.g., a 3D model) to generate a plurality of 2D layers. Each layer of a sliced object may be represented in two dimensions as a planar cross-section of the 3D object. The planar 2D slice may be computed and stored by controller 100.

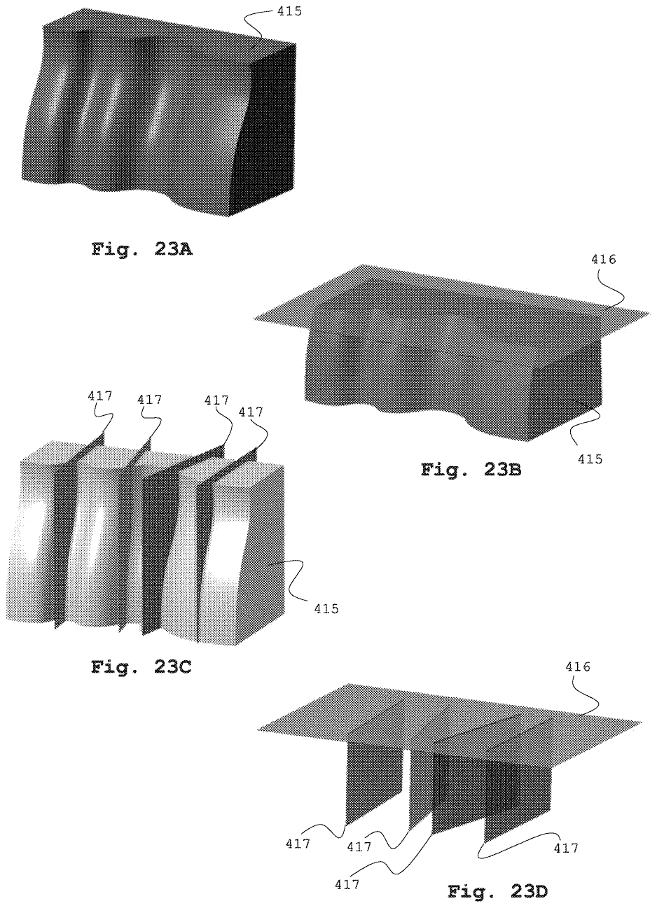

One embodiment of the slicing process is represented in FIGS. 23A-23D, which include a solid model 415 (e.g., a model representing a part to be printed with the additive manufacturing system, such as CNC machine 1) and brace geometry 417 (FIGS. 23C, 23D). Solid model 415 and brace geometry 417 may be suitable for use with an AM-Slice operation (e.g., an operation for slicing a model in a manner that is suitable for an additive manufacturing machine such as CNC machine 1) in which three-dimensional structures are separated into a series of slices (e.g., as described above). The planar cross section of model 415 and planar cross section of brace geometry 417 may be coincident with each other within a particular layer (e.g., a layer at an automatically selected or manually selected slice height 416).

In the description below, the term chain is used to describe 2D geometry. For example, two-dimensional geometry obtained or generated from sliced three-dimensional parts or models. A chain may be a plurality of connected points, lines, or arc segments that exist on a common plane.

Brace geometry may refer to one or more groups of brace surfaces. For example, FIG. 23C contains brace geometry 417 depicted as one group including four individual brace surfaces. A brace surface may be formed by any three-dimensional entity whose planar cross section is a single chain. A brace surface may be one or more connected 3D surfaces or an open sheet body. A chain that is sliced from a brace surface may be referred to as a surface chain. The term “brace shape” encompasses one or more of: a brace surface, a brace geometry, or a brace chain.

For a given layer of an AM-Slice operation, a pass may represent a portion of a toolpath in which material will be deposited (e.g., from nozzle 51). A chain, pass, or other two-dimensional entity that forms a perimeter around a finite area may be closed. Closed entities are cyclical, traversing each segment in a manner that forms a singular loop. Conversely, a chain, pass, or other two-dimensional entity is considered open if it has no finite area (e.g., no closed interior). Open entities have two free ends; traversing segments from one end will always lead to the other.

For a given layer in which brace passes are generated, the passes may be confined to an area defined by that portion of the cross-section of the model that is not occupied by other passes. The areas to which passes are confined can be represented by closed chains, also referred to herein as perimeter chains, that lie parallel to existing passes. Perimeter chains may be calculated using Boolean techniques, offsetting techniques, or any other method that yields one or more closed chains in two-dimensional space that satisfy criteria of the system. If desired, user-specified parameters may indicate the desired overlap between brace passes and existing passes. When applied, perimeter chains are calculated for each group of brace surfaces, such that any resulting pass existing inside or along the perimeter chains will overlap by a specified amount.

FIG. 23B and FIG. 23C show an example solid model 415 and brace surfaces 417. A layer 416 may be selected or defined via an AM-Slice operation.

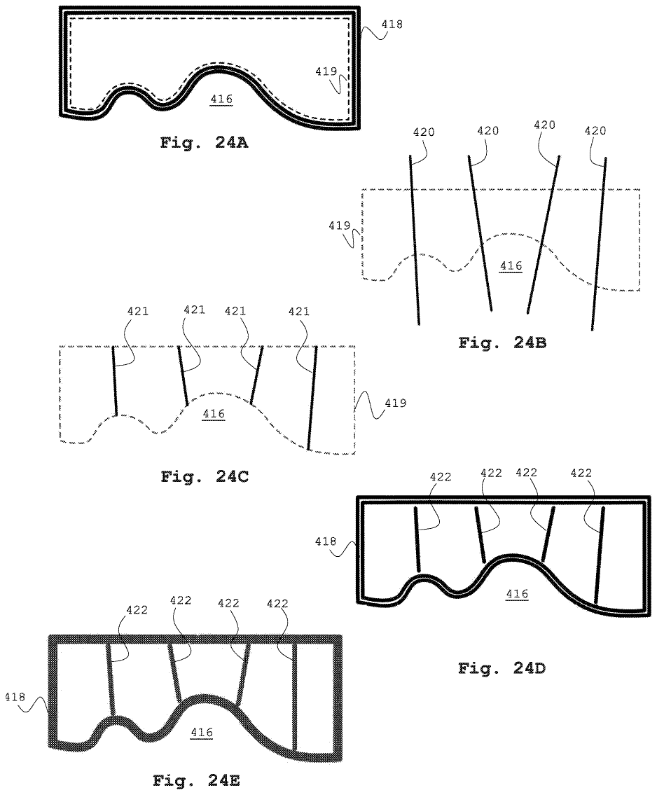

An example embodiment for brace pass generation based on solid model 415 is shown in FIGS. 24A-24E. In particular, FIGS. 24A-24E illustrate an analysis of layer 416 during an autobracing process. FIG. 24A shows two existing passes 418 and a single perimeter chain 419 calculated for layer 416 before brace passes are generated.

With reference to FIG. 24B and FIG. 24C, brace chains 421 (FIG. 24C) may be constructed from segments of the surface chains 420 (FIG. 24B). Surface chains 420 may be formed by processing (e.g., sampling) brace surfaces 417 (FIGS. 23C and 23D), and the perimeter chain 419.

Brace chains 421 (FIG. 24C) represent an initial or intermediary state of the geometry that will become a final brace pass. Brace chains 421 may be created by trimming surface chains 420 along the perimeter chain 419, such that brace chains 421 represent portions of surface chains located inside of perimeter chain 419. The resulting brace passes 422 (FIG. 24D) may follow the same path as the brace chains 421. As shown in FIG. 24E, the final passes 422 for AM-Slice layer 416 may connect to perimeter passes 418.

As indicated above, brace geometry may be provided by the user as one or more groups of user-defined brace surfaces. Each group may have an automatically assigned or user assigned brace type. The brace type may be a parameter set via a user interface, for example. The brace type may be used to determine the manner in which surface chains are interpreted for each analyzed layer.

Brace type may also be used to determine how brace passes are constructed. For example, simple types of brace surfaces result in chains that have limited requirements. Surface chains may be open, closed, and may cross existing passes any number of times (e.g., a number of passes automatically generated or set by a user). For each perimeter chain, any portion of a surface chain found within the interior of the perimeter may be designated as a brace pass. For example, and as described below, a solid model of a rectangular prism may have a base that is normal to the slice direction.

One example layer according to the autobracing process is shown in FIGS. 25A-25D, represented by a rectangular cross section 423 that has two existing passes 424 (FIG. 25B). Passes 424 may represent an outer perimeter that will be formed by printing two closed shapes.

The area available for brace pass creation may be determined with controller 100 and used to define a single closed perimeter chain 425 inside of boundary passes 424. The interior available for brace passes may be enclosed by perimeter chain 425. Areas outside of perimeter chain 425 may be ineligible for placement of a brace pass.

An open chain 426 may be sliced or otherwise defined based on a simple type brace surface. A portion of open chain 426 may be a simple brace surface present within perimeter chain 425. Each intersection 427 between closed perimeter chain 425 and surface chain 426 may be determined, with points between intersections 427 being determined as a portion of open chain 426 within closed perimeter chain 425. Intersections 427 may be used to divide surface chain 426 into three segments. In the illustrated example, one segment exists inside perimeter chain 425. As a result, a single open brace pass 428 is created on the layer using the segment inside perimeter chain 425.

Brace surfaces may include functions in addition to being used to set the shape of brace passes 428. A direction may be determined for open surface chains 426 on a layer. Resulting open passes may follow the direction of the brace surface with respect to existing passes. This may include using intersections 427 and discarded segments of each surface chain 426 to determine or identify the direction for surface chain 426. The identified direction of surface chain 426 may be used in any suitable method in which open brace passes 428 are created, regardless of the brace type that is manually or automatically selected for the brace generation process. In some examples, brace chains and passes may be oriented to follow the same direction as the surface chain from which they were derived.

As shown in FIG. 25D, an open surface chain 428 may have two open ends. Accordingly, the direction of open surface chain 428 may be represented by creating a start point and a finish point. This may include selecting the start point as the open end with the shortest distance to perimeter chain 425. For surface chains with two or more intersections, the distance may be measured along the chain from an open end to the nearest intersection 427. If fewer than two intersections 427 exist, the distance may be measured as the shortest distance to any point along the perimeter chain.

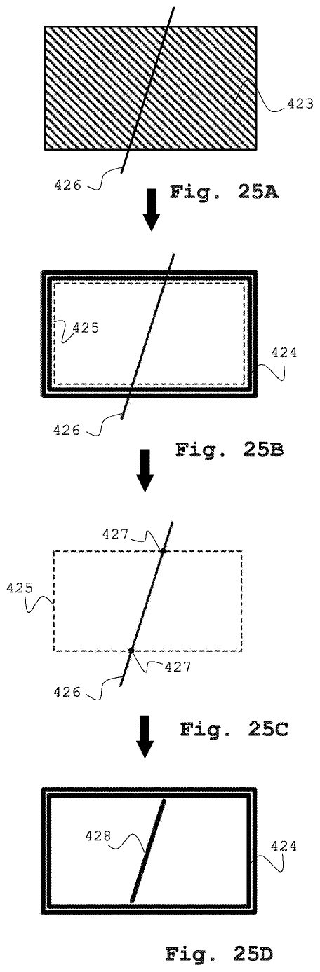

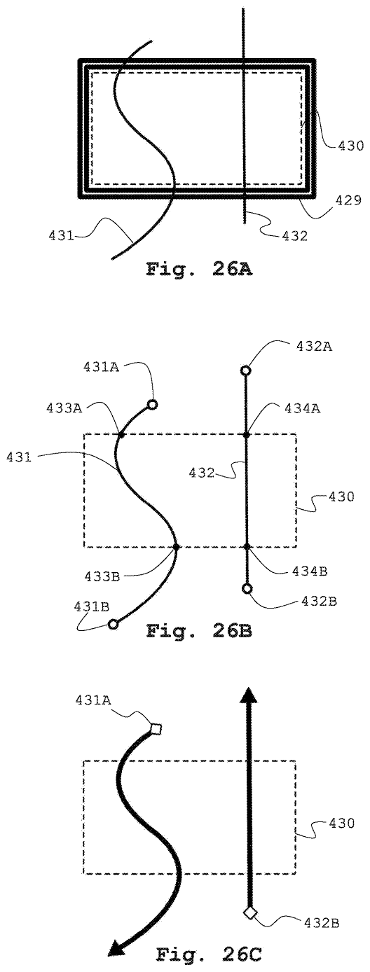

An embodiment for determining the direction of open surface chains (the identified direction also being referred to herein as an “implied” direction) is shown in FIGS. 26A-26C. An example layer of an AM-Slice operation is represented by passes 429 in FIG. 26A. Passes 429 may define a perimeter chain 430 (FIG. 26B).

Two surface chains, including a curved surface chain 431 and a linear surface chain 432 extend in the illustrated layer. Controller 100 may measure first distance along curved surface chain 431 between a first open end 431A and a first intersection 433A. A second distance along curved surface chain 431 may be measured with controller 100 from a second open end 431B to a second intersection 433B.

In the illustrated example, the first distance is shorter than the second distance. Based on this, the implied direction of curved surface chain 431, as determined with controller 100, is from open end 431A to open end 431B, with first open end 431A being designated as the start point.

The distance along straight surface chain 432 between open ends 432A and 432B and intersections 434A and 434B may also be determined with controller 100. A start point may be determined at second open end 432B of straight surface chain 432 in the example illustrated in FIG. 26B. The resulting directions are represented as arrow heads in FIG. 26C.

In some circumstances, an implied direction from surface chains is not determined for closed brace passes. Accordingly, a default direction, or if desired, a user-defined direction, may be established for closed brace passes. For example, all closed brace passes may be oriented to follow a clockwise or counterclockwise direction. The direction may be determined to be the as the direction of adjacent passes (e.g., passes that correspond to the geometry of the part). If no portion of the brace pass lies parallel to an existing pass the default direction for the operation may be applied.

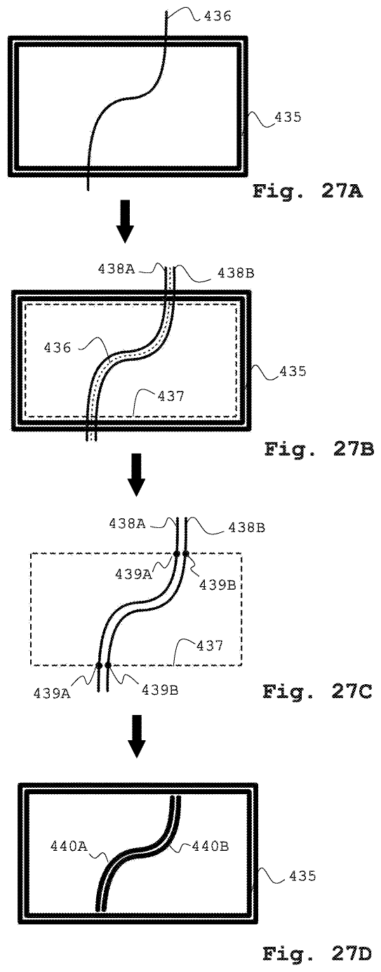

In some examples, and with reference to FIGS. 27A-27D, brace surfaces may have a double type. These double type brace surfaces may include at least one intersection and a segment within perimeter chain 437. Brace surfaces having a double type configuration may be used to create two or more passes along the same surface chain. As an example, double type passes may be constructed along two duplicate surface chains, each of which is equidistant and parallel to the original brace surface.

If desired, an additional parameter may be used to specify the separation distance of double type passes. Values may be determined, such as the magnitude of a distance between the centerlines of passes. An overlap amount for which a centerline distance may be calculated from bead width.

One embodiment for double type pass creation will be described with reference to FIGS. 27A-27D. An example layer of an AM-Slice operation is shown in FIGS. 27A-27D with existing passes 435 forming an outer boundary of the layer. FIGS. 27A-27D also show an open surface chain designated as a double type surface chain.

Controller 100 may determine a single perimeter chain 437 based on passes 435, as described above. Offset surface chains 438A and 438B (FIG. 27C) may be created such that a perpendicular line will intersect the right 438A and left 438B chains (e.g., at a specified or predetermined distance) from any point along an original surface chain 436. For the purposes of this example, the specified (e.g., user or automatically selected) distance creates overlapping passes. For the right and left offset chains 438A and 438B, corresponding intersections 439A and 439B are formed along perimeter chain 437. As described above, chains can be oriented to establish a direction along which a nozzle will move, and broken into segments.

As described herein, controller 100 may be configured to generate one or multiple types of brace passes or surface chains. Double type brace passes 440A and 440B are shown in FIG. 27D. Passes 440A and 440B may be created along segments within perimeter chain 437.

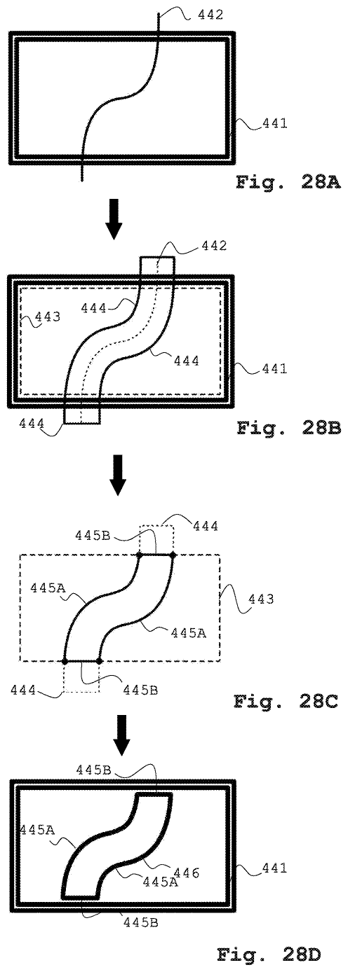

If desired, instead of double type brace surfaces, brace surfaces may be created using connected type brace passes (e.g., as shown in FIGS. 28A-28D). The connected type may be used to create closed brace passes from open surface chains. Connected type surface chains on a given layer may share any of the features as the double type surface chains described above or may have different features. Passes generated from connected type brace surfaces will be formed along offset subsegments of the original surface chain and subsegments of the perimeter chain.

A connected offset chain may be generated around each applicable surface chain. Resulting closed brace passes may be the result of a Boolean operation performed at the intersection between the perimeter and connected offset chain. In at least some examples, passes that result from a connected type surface chain are coterminous with passes for double type surface chains, the connected type passes being extended to form a closed loop along adjacent existing passes.

An embodiment for connected type pass creation is represented in FIGS. 28A-28D. Boundary passes 441 and an open surface chain 442 are shown in FIGS. 28A-28D. Using methods discussed above, controller 100 may determine a perimeter chain 443 along the interior of passes 441. A connected offset surface chain 444 may be constructed (e.g., as described above) such that, from any point along surface chain 442, a perpendicular line intersects both sides of offset surface chain 444 at a specified distance (e.g., the same distance). The perpendicular line may connect the respective ends of each offset chain 444 at each end of surface chain 442.

Perimeter chain 443 and connected offset chain 444 may be broken into segments at their intersections, as shown in FIG. 28C. With reference to FIG. 28D, a resulting brace pass 446 for this layer contains connecting segments 445A of the connected offset chain that lie within the perimeter chain 413 as well as segments 445B of the perimeter chain 413 that lie within the connected offset chain.

Another type of brace surface is referred to herein as an inverted type. Inverted type brace surfaces may be used to create one or more closed brace passes. Inverted type braces, also referred to as inverted connected type braces, may have any of the above-described characteristics and features of the connected type braces. Passes generated from inverted type brace surfaces create one or more closed loops that follow the perimeter chain and connect along offset chains from the original surface. Inverted type braces may, in contrast to connected type braces, connect along the perimeter along an inverse direction, as described below.

When inverted type braces are used, the number of passes may increase by one for each surface chain with two intersections. Resulting closed brace passes can be represented as the result of a Boolean subtraction between the perimeter and connected offset chains.

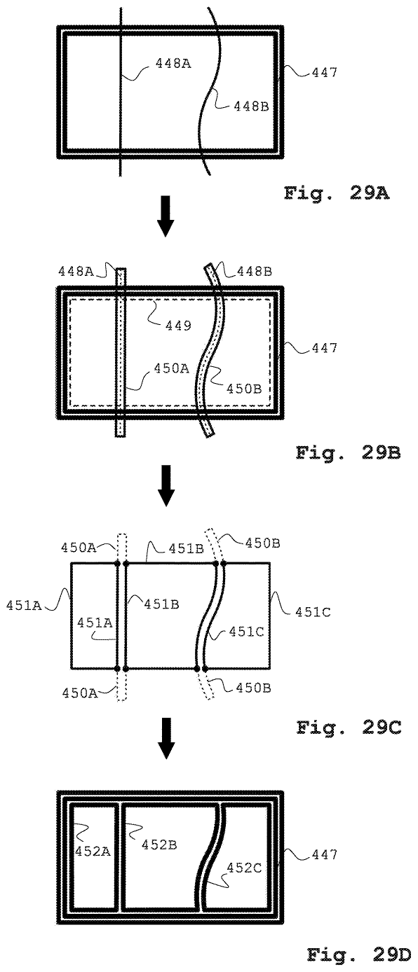

One example for inverted type pass creation for inverted type braces is represented in FIGS. 29A-29D. Part passes 447 (e.g., previously-defined passes or passes that represent structural features of the part) and two open surface chains 448A and 448B are shown. Using the methods described above, a perimeter chain 449 can be calculated along the interior of existing passes 447. Offset chains 450A and 450B may be determined and connected from surface chains 448A and 448B.

Perimeter chain 449 may be altered or divided into multiple loops by an appropriate technique (e.g., via a Boolean subtraction or other method). In the illustrated example, three closed loops 451A-451C are determined. Closed loops 451A-451C may each correspond to segments of perimeter chain 449 that are not contained in the connected offset chains 450A and 450B and portions of the connected offset chains 450A and 450B that exist within the perimeter 449. In this embodiment, the resulting closed loops 451A and 451B become the final inverted type brace passes 452A, 452B, and 452C for the layer, as shown in FIG. 29D.

Some aspects of the disclosure relate to another type of brace, referred to herein as an intersection type, that can be generated with controller 100. Intersection type braces may be used to create a variety of brace structures as open or closed passes from a single open chain. In contrast to other brace types, such as the brace types described above, intersection type surfaces may include surface chains on a layer that have exactly two intersections with a perimeter chain.

Optional parameters may be applied to specify the shape of the entire pass or behavior near each intersection of the surface chain. Original surface chains may be duplicated, translated, or replaced with predefined geometry to generate passes. Resulting passes may or may not share the same shape as the original surface, relying only on the location and implied direction of surface chains.

A variation of intersection type passes may employ offset surface chains in a manner that corresponds to that of double type or connected type passes. For example, using the implied direction of the surface chain, additional parameters may specify the manner of connecting chains with existing passes near each intersection. These connection types include, for example, “butt”, “bridge”, “I-beam”, and “valve.”

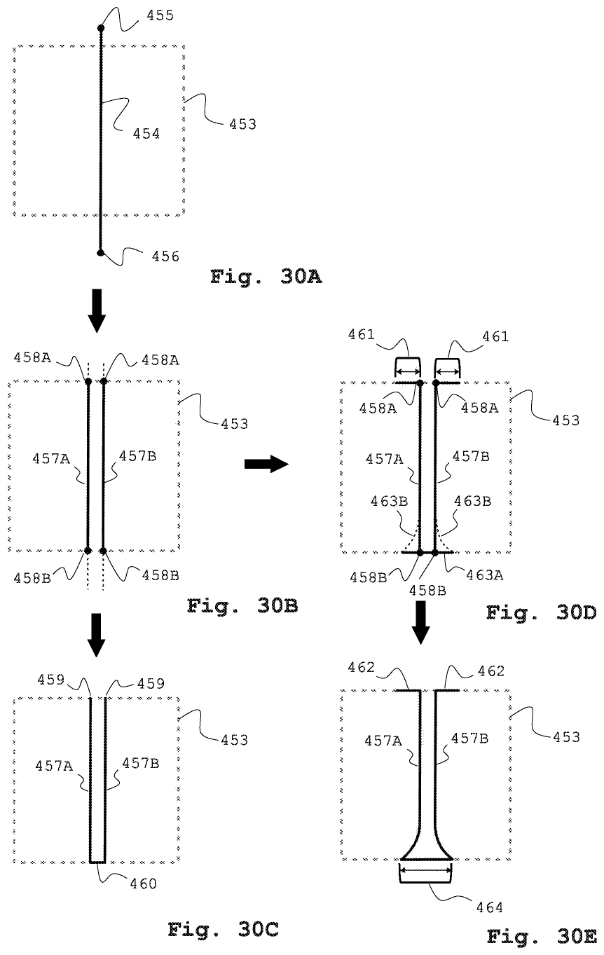

Butt connections may mimic the behavior of intersections for double type and passes. Bridge connections may include features of connected type passes. The embodiments from FIGS. 30A-30E show a perimeter chain 453 of an example layer and a surface chain 454 with two intersections. Implied direction is used to determine a start-point 455 and finish-point 456. In this example, offset surface chains 457A and 457B are constructed and trimmed at intersections 458A and 458B as shown in FIG. 30B.

In FIGS. 30A-30C, trimmed intersections 458A near the start-point are left un-changed, creating a “butt” connection 459 (FIG. 30C). Intersections 458B near the finish-point are connected along the perimeter chain to form a “bridge” connection 460.

I-beam and valve connections may traverse perimeter chain 453 in each direction of the intersection, creating one or more segments along existing passes. Alternative variations of intersection type pass creation may offset, translate, or replace portions of the surface chain. For example, in FIGS. 30D and 30E, intersections 458A near the start-point are extended by segments 461 of the perimeter chain to form an “I-beam” connection 462 shown in FIG. 30E. Intersections 458B near the finish-point, along with portions of the offset chains 457A and 457B, are replaced by a perimeter segment 463A and curved segments 463B that are generated to form a “valve” connection 464 (FIG. 30E).

In some examples, the geometry of the part (e.g., the solid model representing the part) is complex. This complexity may result in generation of complex bracing structures. Advanced type brace surfaces, for example, may be used for complex geometry to avoid the need to submit or generate additional parameters or use pre-defined shapes for the brace structure. Chains sampled from advanced type surfaces may use segments to construct passes, whereby portions of the surface chain outside the perimeter may be replaced by portions of the perimeter chain that exists between two intersections. Passes may be generated for any surface chain with at least two intersections with a brace perimeter within a particular layer of the model. For open surface chains, intersections may be used to determine the implied direction. Segments before the first intersection and after the last intersection may be ignored or removed.

In some aspects, open surface chains may produce open brace passes. Advanced type passes may be constructed by traversing the segments between intersections, identifying and retaining passes within the perimeter chain and replacing passes that are outside of the perimeter chain for one or more open brace passes.

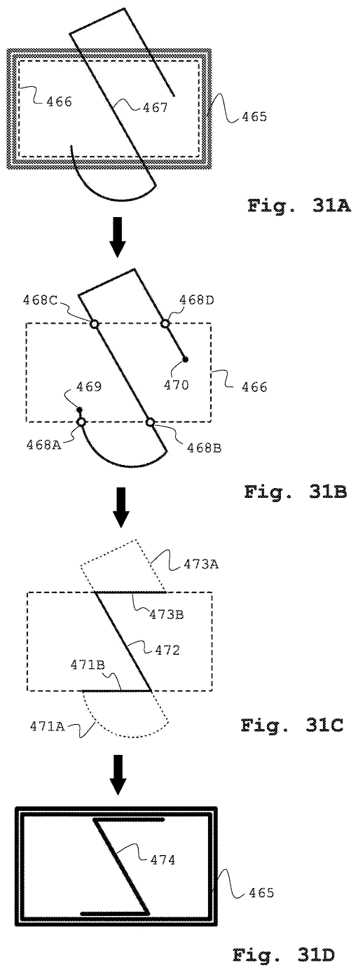

An example of advanced type brace pass creation is shown in FIGS. 31A-31D. An example layer of an AM-Slice operation is shown in FIG. 31A with existing passes 465 that form a portion of the part. FIG. 31A also shows a perimeter chain 466 calculated with controller 100 based on part passes 465 and an open surface chain 467. Using the above-described processes, four intersections 468A-468D may be identified and used to establish the implied direction of surface chain 467. In the illustrated example, the implied direction begins at start point 469 and traverses surface chain 467 to finish point 470. The first segment of surface chain 467 may extend from start point 469 to first intersection 468A. The final segment of surface chain 467 may extend from a final intersection 468D to finish point 470. The first segment and the final segment may both be removed or discarded as these segments are outside of perimeter chain 466. A brace pass 474 may then be constructed with three segments 471B, 472, and 473B that are located within perimeter chain 466.

From the process described above, open surface chains sampled from advanced type surfaces involve two intersections. In these examples, surface chains with only one intersection are not used to create passes. Furthermore, open surface chains with exactly two intersections may mirror the behavior of simple type braces, as no implied segments are present. The behavior for closed surface chains, with two or more intersections, may differ slightly. As previously described, closed chains may have no open ends, thus segments before the first intersection and after the last intersection are not discarded. Closed surface chains, sampled from advanced type brace surfaces, may create closed passes if two or more intersections exists.

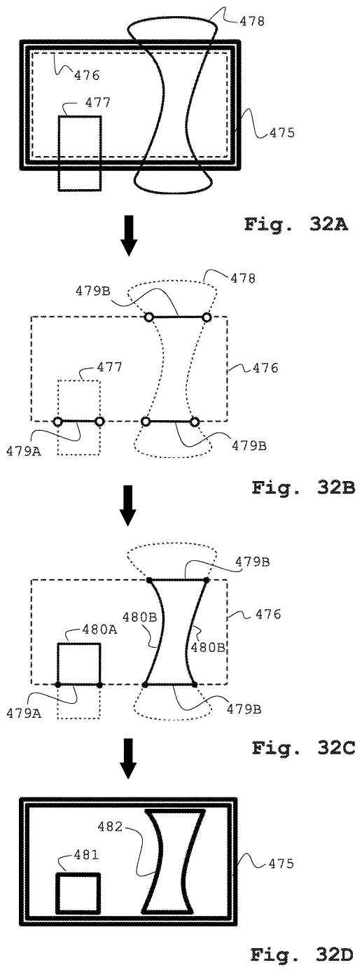

Implied segments may be created for any portion of a perimeter chain contained within the closed surface chain. One embodiment of a method for forming segments for a perimeter chain within a closed surface chain is illustrated in FIGS. 32A-32D.

An example layer represented in FIG. 32A includes existing passes 475. A single perimeter chain 476 may be defined based on passes 475. Two closed chains 477 and 478 are shown in FIG. 32A. Chains 477 and 478 may be sampled from advanced type surfaces. A rectangular surface chain 477, as shown in FIG. 32A, has two intersections. These intersections are connected by a single implied subsegment 479A as shown in FIG. 32B.

In FIG. 32B, second surface chain 478 is shown with four intersections and with two implied segments 479B. A closed brace pass 481 (FIG. 32D) may be created from segments 480A of the rectangular surface chain 477 that exist inside perimeter 476, and the corresponding implied segment 479A. A closed brace pass 482 may be created from second surface chain 478 by incorporating implied segments 479B along perimeter 476, and segments 480B inside perimeter 476.

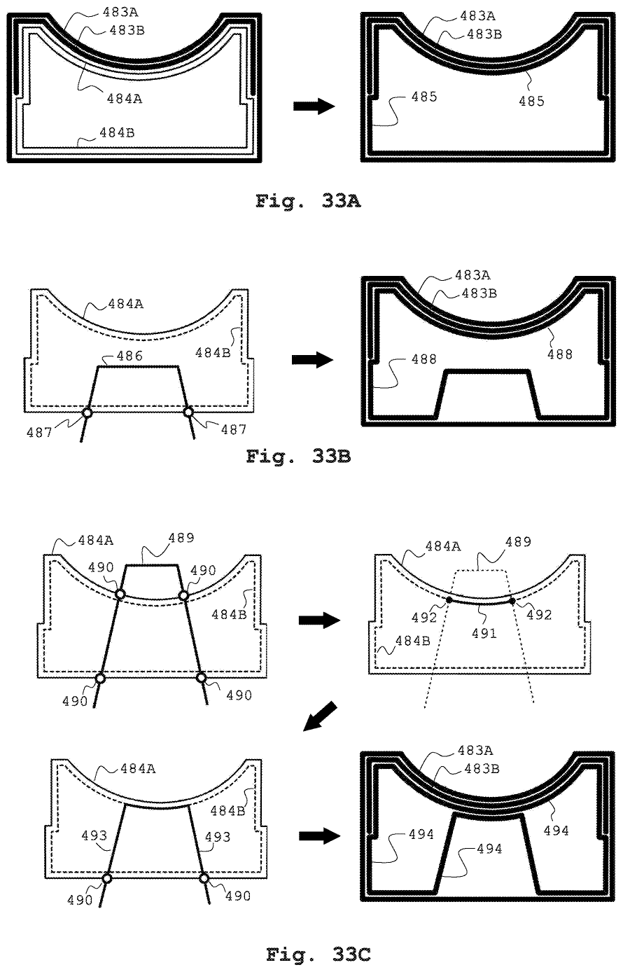

An additional type of brace generated with controller 100 is a hybrid type brace, as shown in FIGS. 33A-33C. A hybrid type brace may be used to create one or more unified closed passes within the available space on each layer. Hybrid type surface chains for the hybrid type brace may be open with respective open ends that are not contained within existing passes. For a given layer, using techniques described above for example, two concentric perimeter chains may be calculated within each available area. These concentric chains are referred to as the outer and inner perimeter below.

Each pair of perimeter chains may be calculated such that passes created along their segments overlap as specified, with existing passes and outer segments respectively. Each hybrid type surface chain may have an even number of intersections (e.g., two intersections, four intersections, six intersections, etc.) with the outer perimeter.

A hybrid type brace pass may be constructed along the outer perimeter chain only in configurations where the outer chain has no intersections with a surface-chain. One embodiment of this process is shown in FIG. 33A. FIG. 33A shows an example layer from an AM-slice operation, represented with one closed pass 483A and one open pass 483B, passes 483A and 483B representing portions of the part that will be manufactured. An outer perimeter chain 484A and inner perimeter chain 484B may be constructed inside the area internal to passes 483A and 483B. A brace pass 485 may be constructed along the outer perimeter chain 484A when a hybrid type surface chain exists outside both perimeters.

Segments of both intersections may be used if an outer chain has two intersections with a hybrid type surface chain. Passes may be constructed by using portions of the surface chain within outer perimeter 484A, connected by the longest segment of outer perimeter chain 484A that connects to both intersections. One embodiment can be found in FIG. 33B. An example layer of an AM-Slice operation is represented by an outer perimeter chain 484A, an inner perimeter chain 484B, and a hybrid type surface chain 486. As outer perimeter 484A and surface chain 486 share two intersections 487, the inner perimeter not necessarily utilized. A hybrid type brace pass may be constructed based on the interior segment of surface chain 486 and the longest subsegment of outer perimeter 484.

FIG. 33C shows an example layer of an AM-Slice operation. With reference to FIG. 33C, segments from all three chains may be used to create a hybrid type pass when the outer chain has four intersections with a surface chain. An implied segment between the second and third intersection may replace a portion of the original surface chain, using inner perimeter 484B. Surface chain 489 may be modified to have only two intersections 492 with outer perimeter 484A, intersections 492 being used to create a pass 419 (e.g., via the above-described techniques).

Outer perimeter chain 484A and inner perimeter chain 484B are shown for an area within existing passes 483A and 483B. In the illustrated embodiment, hybrid type surface chain 489 has four intersections 490 with the outer perimeter 484A. In this instance, four intersections (not shown) with inner perimeter 484B may be present. A segment 491 of inner perimeter 484B may be determined between intersections 492 by traversing surface chain 489 in either direction. A modified surface chain 493 may be created based on the segment 491. Surface chain 493 may retain two intersections 490 with the outer perimeter chain 484A. A unified hybrid type brace pass 494 may be created using the processes described above.

The descriptions and embodiments described herein, including embodiments pertaining to brace type pass creation, are non-limiting examples of the disclosed methods. Other embodiments of the disclosure may be more complex. For example, layers may contain disjointed areas, inner contours, and related surface chains.

Disjointed areas may be found when a single perimeter chain inside existing passes becomes narrow enough that a brace pass created along the perimeter would overlap itself (e.g., by an amount that is greater than a threshold overlap value or overlap parameter). A series of geometric operations may be used to pre-process each perimeter chain such that resulting chains satisfy an overlap parameter. Brace passes may be created recursively for each set of perimeter chains or surface chains of the same brace type. In the presence of multiple surface-chains from different brace types, processing each group may require updating all perimeter chains. This allows for the trimming or nesting of brace passes by treating previous brace passes as existing passes.

In the case of inner contours, the available area inside the model is defined by an outer wall and one or more inner walls. Consider a model whose cross section is similar to that of a sliced bagel or torus. Assuming existing passes are present along the outer edge and inner edge of the model, the available space would be defined by two related perimeter chains. In the presence of inner contours, perimeter chains are grouped together as one outer chain and all inner chains encompassed by the outer chain. Brace pass creation, for a given group of perimeter chains, may involve creating an initial brace pass using only the outer chain and surface chain with methods previously disclosed. For each inner surface chain, the initial pass may be updated using inverse logic until a final pass is created, handling the area within each inner chain as outside of existing passes or the model's cross section.

To accommodate any limitations of brace pass creation for a given brace type, pass modifiers may be used to achieve desired shape or behavior of resulting passes. Each brace type may have any number of pass modifiers provided as additional 3D solid geometry or applicable parameters.

Variable radius fillets represent an exemplary method of pass modification, used to replace portions of the original pass with arc segments. When applied, variable radius fillet methods may traverse passes to detect qualifying corners or target those near intersections of the brace surface originally provided. In practice, parameters may be exercised to provide corner criteria and a target radius. To ensure the original shape is maintained, each corner is weighted by the minimum distance along the pass to adjacent corners or open endpoints. For a given corner in which a reasonable arc may be inserted, an ideal radius may be calculated with the provided target radius, angle of deviation, and less than half its weighted distance. The pass may be broken into three segments and connected such that an ideal radius fillet arc replaces the middle subsegment.

Exclusion volumes, also be referred to as check volumes, represent another example of pass modification. For a given brace type one or more 3D solids may be specified as exclusion volumes. Each volume may be sliced incrementally, coincident with existing layers of the operation. For each layer in which exclusion volume slices are found multiple closed exclusion chains are calculated and stored. For a given layer in which brace passes of the specified type and applicable exclusion chains are present, any subsegment of a brace pass found within an exclusion chain may be discarded. In practice, exclusion volumes may be used to create holes in resulting brace structures or remove undesirable portions of brace passes on one or more layers. Additionally, brace surface behaviors may be maintained with the application of exclusion volumes. Using methods previously described, brace passes broken or segmented by exclusion volumes may maintain the implied direction of the original brace surface.

The systems and methods disclosed offer an alternative approach to generating internal bracing structures for parts created using additive manufacturing. Such an approach utilizes one or more groups of supplemental three-dimensional (3D) geometry to dictate the shape, direction, and behavior of internal structures. The method works in tandem with other processes for boundary pass creation, processing geometry in two dimensional (2D) layers.

As indicated, the discussion relating to bracing features may be used with the additive manufacturing apparatus described above. Additionally or alternatively, the bracing features may be used with additive manufacturing systems and apparatuses, such as those disclosed in U.S. Pat. No. 10,336,050, issued on Jul. 2, 2019, U.S. Pat. No. 10,611,073, issued on Apr. 7, 2020, U.S. Pat. No. 10,449,710, issued on Oct. 22, 2019, U.S. Pat. No. 10,723,074, issued on Jul. 28, 2020, and U.S. Pat. No. 10,786,944, issued on Sep. 29, 2020, each of which is incorporated by reference in its entirety.

The above disclosure, and FIGS. 22A-33C, provide an approach for creating internal structures for parts produced with additive manufacturing. Such an approach may utilize supplemental three-dimensional (3D) geometry and optional parameters to create bracing structures. One role of this supplemental geometry, also referred to as brace geometry, is to dictate the shape of the resulting brace structure(s) inside the part. The application of these methods may be used to extend the functionality of any existing system which creates toolpaths or executable programs for use with additive manufacturing. The exemplary methods will be represented by “Brace” pass(es) or toolpath(s) generated by a slicing software operation as an addition to the above-described toolpaths.

The printing process to manufacture the part produced by the slicing process may print a first layer of a first section in a manner such that the first layer overlaps, contacts, and/or meshes with a first layer of a second section. In some examples, the separate sections of the manufactured part may be printed by the CNC machine 1 so that the sections meld, join, or otherwise attach to one another. That is, in contrast to the formation of separate portions which are subsequently assembled to form a part, the methods described herein may permit each of the separate sections of a part to be printed in a single printing process to form the part.

From the foregoing detailed description, it will be evident that there are a number of changes, adaptations and modifications of the present disclosure which come within the province of those persons having ordinary skill in the art to which the aforementioned disclosure pertains. However, it is intended that all such variations not departing from the spirit of the disclosure be considered as within the scope thereof as limited by the appended claims.

1. A system for forming a part using additive manufacturing, the system comprising:
an applicator assembly including a nozzle connected downstream of an extruder;
a plurality of servomotors for positioning the applicator assembly; and
a controller configured to generate instructions for controlling operation of the plurality of servomotors to position the applicator assembly, the controller being further configured to:
receive a model of a part,
determine a brace type from a plurality of brace types,
generate, based on the model of the part, a brace shape,
identify a first portion of the brace shape located on an interior of the model and a second portion of the brace shape located outside of the interior of the model, and
based on the brace type, generate the instructions for controlling operation of the plurality of servomotors to deposit material to physically form the portion of the brace shape at a location that corresponds to the interior of the model of the part.

2. The system of claim 1, wherein the controller is further configured to generate a bracing geometry, based on and by removing a portion of the brace shape, the bracing geometry having a series of separate walls.

3. The system of claim 1, wherein the controller is further configured to generate a bracing geometry, based on and by removing a portion of the brace shape, the bracing geometry having a series of walls having curved portions.

4. The system of claim 1, wherein the controller is further configured to generate a bracing geometry, based on the brace shape, the bracing geometry having a series of walls that are connected to each other at the interior of the model of the part.

5. The system of claim 1, wherein the controller is further configured to generate a perimeter that surrounds the interior of the model of the part and exclude the second portion of the brace shape based on the second portion of the brace shape being outside of the perimeter.

6. The system of claim 1, wherein the controller is further configured to:
generate a perimeter that surrounds the interior of the model of the part, and
generate a connector, of a bracing geometry, that extends parallel to the perimeter in a manner that connects a pair of bracing walls, the bracing geometry being determined based on the brace shape.

7. The system of claim 1, wherein the controller is further configured to:
generate a perimeter that surrounds the interior of the model of the part, and
generate a series of bracing walls based on the portion of a bracing geometry that is located on the interior of the model of the part.

8. The system of claim 1, wherein the controller is further configured to:
generate a perimeter that surrounds the interior of the model of the part,
generate a series of bracing walls based on the portion of a bracing geometry that is located on the interior of the model of the part, and
generate connectors extending between pairs of bracing walls.

9. The system of claim 1, wherein the controller is further configured to:
generate a perimeter that surrounds the interior of the model of the part,
generate a series of bracing walls based on the portion of a bracing geometry that is located on the interior of the model of the part, and
generate connectors extending between pairs of bracing walls, the connectors forming areas of increased thickness on the perimeter.

10. A method for forming a part using an applicator assembly including a nozzle connected downstream of an extruder the method comprising:
receiving a model of a part;
generating, based on the model of the part and a brace type selected from a plurality of brace types, a brace shape;
identifying a portion of the brace shape that is located on an interior of the model of the part; and
generating instructions for controlling operation of a plurality of servomotors for depositing material on the portion of the brace shape located on the interior of the model of the part.

11. The method of claim 10, further including determining a direction of a brace chain that forms a portion of the brace shape, the direction representing motion of a nozzle from a start of the brace chain to an end of the brace chain, the direction being determined based on portions of the brace shape that are outside of the interior of the model.

12. The method of claim 10, further including determining a brace chain that forms a portion of the brace shape, the brace chain having a curved shape within the interior of the model.

13. The method of claim 10, wherein the brace type is a double type, the double type including a pair of parallel brace portions.

14. The method of claim 10, wherein the brace type is a double type, the double type including a pair of parallel brace portions, the parallel brace portions being curved.

15. The method of claim 10, wherein the brace shape has a series of walls that are connected to each other at the interior of the model of the part to form a closed loop.

16. The method of claim 10, wherein the brace type forms a curved end portion and a straight central portion.

17. The method of claim 10, wherein the brace type forms a plurality of linear portions and at least one curved portion, the linear portions and the at least one curved portion being within the interior.

18. The method of claim 10, further comprising:
generating a perimeter that surrounds the interior of the model of the part; and
generating the brace shape such that the brace shape connects to the perimeter.

19. The method of claim 10, further comprising:
generating a perimeter that surrounds the interior of the model of the part; and
generating the brace shape such that the brace shape is spaced away from the perimeter.

20. The method of claim 10, further comprising:
generating a perimeter that surrounds the interior of the model of the part; and
generating the brace shape such that the brace shape has a curved portion that intersects with the perimeter.
